(19) United States
(12) Patent Application Publication
(10) Pub. No.: US 2007/0226075 A1
(43) Pub. Date: Sep. 27, 2007

(54) Transaction Method of Reusable Parts

(75) Inventors: Yuzo Hiroshige, Tokyo (JP); Hirotaka Obata, Hiratsuka (JP); Mitsuhiro Enomoto, Fujisawa (JP); Tomotoshi Ishida, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/757,223

(22) Filed: Jun. 1, 2007

Related U.S. Application Data
(62) Division of application No. 09/859,238, filed on May 16, 2001, now abandoned.

(30) Foreign Application Priority Data
Dec. 11, 2000 (JP) 2000-381642

(51) Int. Cl. G06Q 30/00; G06Q 10/00

(52) U.S. Cl. 705/26; 705/28

(57) ABSTRACT

The present invention gives techniques for using an information system, including a computer, to provide a user, such as a manufacturer, with reusable parts for use in the building of or maintaining a product. In one embodiment of the present invention, a method, using a computer, for buying a reusable part for use in manufacturing a product is provided. The method includes a user sending to a supplier requirements for the reusable part; Next the users receives information on a plurality of available reusable parts meeting or exceeding said requirements from the supplier (or broker). The information includes individual historical information for each available reusable part. The user then orders an available reusable part and uses the reusable part in manufacturing the product.

### CROSS-REFERENCES TO RELATED APPLICATIONS

This application is a Divisional of U.S. patent application Ser. No. 09/859,238, filed May 16, 2001, and is related to and claims priority from Japanese Patent Application No 2000-381642, filed on Dec. 11, 2000, each of which is incorporated herein by reference for all purposes.

### BACKGROUND OF THE INVENTION

This invention generally relates to an information system in support of transactions involving reusable parts and more particularly to the obtaining of reusable parts for use in manufacturing products.

Products have been assembled from only new parts so far because new parts are stable in quality and supply. Although reusable parts have been used in the manufacturing of copying machines and rolls of film with a lens, their use has been limited to in-house closed-loop recycling. This occurs when a manufacturer has its used products on hand. There has not been open-loop recycling of reusable products; that is where a reusable (or used) part(s) is purchased by the manufacturer for installation in a new product (or a product to be sold as new). This includes cascade recycling (for example, recycling of used parts of high-technology devices for the manufacturing of toys). Thus used components, which may have remaining lifespans that may be more than adequate for the manufactured product, are being wasted.

However, traditionally it has been difficult to secure a stable supply of reusable parts, and this has been an obstacle to open-loop recycling. Smooth procurement has been a problem awaiting solution for manufacturers. In addition, if a supplier prepares reusable parts and has them in stock, but no stable users, the value of its inventory decreases daily and the supplier incurs storage expenses every day.

Each individual part has its own unique service history and hence the values of reusable parts vary from part to part. No procurement and supply system of reusable parts has so far been available which copes with this problem.

Thus there is a need for techniques which enable users, for example, manufacturers, and suppliers of reusable parts to deal with each other smoothly and efficiently. And for the use of reusable items in manufactured products.

### SUMMARY OF THE INVENTION

The present invention gives techniques for using an information system, including a computer, to provide a user, such as a manufacturer, with reusable parts for use in the building of or maintaining a product.

In one embodiment of the present invention, a method, using a computer, for buying a reusable part for use in manufacturing a product is provided. The method includes a user sending to a supplier requirements for the reusable part; Next the users receives information on a plurality of available reusable parts meeting or exceeding said requirements from the supplier (or broker). The information includes individual historical information for each available reusable part. The user then orders an available reusable part and uses the reusable part in manufacturing the product.

In an alternative embodiment a computerized method for obtaining a plurality of parts for producing a product to be sold as a new product is provided. The said method include, first: determining a total number of the plurality of parts used in producing the product, wherein the total number includes a used part and a new part. Next, the supplier is sent a used part past use requirement; and the user receives ordering information on said used part and past use information on said used part from the supplier. The user selects the used part, if the past use information of the used part at least meets the used part past use requirement. The past use information may include service time and the number of times of repair.

In another embodiment of the present invention, reusable-part inventory information is provided to a supplier of reusable parts. Further, between the user of reusable parts and the supplier of reusable parts, various kinds of information are exchanged as reusable-part procurement/supply information, which includes information necessary for reusable part trading. For example, a part name or a model designation, a required number of parts, requested delivery date, suggested price, and individual part. Thus, the supplier of reusable parts efficiently distributes the reusable parts by extracting, from a reusable-part inventory, the parts meeting the users requirements, such as the parts with histories meeting the needs of users. Further, the user of reusable parts efficiently manufactures products by incorporating the procured reusable parts in the products.

In yet another embodiment a user of reusable parts transmits information on its needs for reusable parts to a supplier. The supplier prepares availability information on available reusable parts based on the information on the user's needs and its inventory information and transmits the availability information to the user. The user chooses reusable parts meeting its needs and the supplier supplies the user with them. The user manufactures products by using the above reusable parts.

These and other embodiments of the present invention are described in more detail in conjunction with the text below and attached figures.

### BRIEF DESCRIPTION OF THE DRAWINGS

FIG. 1 shows a configuration of devices according to an embodiment of the present invention.

FIGS. 2a and 2b shows a system configuration according to an embodiment of the present invention.

FIG. 3 shows a work flow between user and supplier according to an embodiment of the present invention.

FIGS. 4a and 4b show a work flow of a user of reusable parts according to an embodiment of the present invention.

FIG. 5 shows databases for a user of reusable parts according to an embodiment of the present invention.

FIG. 6 shows more database for a user of reusable parts according to an embodiment of the present invention.

FIG. 7 shows user's reusable parts screen according to an embodiment of the present invention.

FIGS. 8a and 8b show a work flow for a supplier of reusable parts according to an embodiment of the present invention.

FIG. 9 shows an example of the database for a supplier of reusable parts according to an embodiment of the present invention.

FIG. 10 shows examples of graphs of failure rate versus service time for parts.

FIG. 11 shows a configuration of devices according to another embodiment of the present invention.

FIGS. 12a, 12b, and 12c shows a system configuration according to another embodiment of the present invention.

FIG. 13 shows a work flow between a user, supplier, and broker of another embodiment of the present invention.

FIGS. 14a, 14b, 14c, and 14d show a work flow of a broker of reusable parts according to another embodiment of the present invention.

FIGS. 15a and 15b show databases for a broker of reusable parts according to another embodiment of the present invention.

FIG. 16 shows a configuration of devices according to a third yet another embodiment of the present invention.

FIGS. 17a and 17b shows a system configuration according to a third embodiment of the present invention.

FIGS. 18a, 18b, 18c, and 18d show an example of the database for a user of reusable parts according to third embodiment of the present invention.

FIG. 19 shows a user reusable parts screen according to a third embodiment of the present invention.

FIGS. 20a and 20b show a database and system for a user of reusable parts according to a fourth embodiment of the present invention.

FIGS. 21a, 21b, and 21c show more databases for a user of reusable parts according to a fifth embodiment of the present invention.

FIG. 22 shows a system configuration according to a sixth embodiment of the present invention.

FIG. 23 is an example of the work flow between a supplier and user according to a sixth embodiment of the present invention.

FIG. 24 is a user search screen for a user of reusable parts according to a sixth embodiment of the present invention.

FIG. 25 is a user screen showing search results according to a sixth embodiment of the present invention.

### DESCRIPTION OF THE SPECIFIC EMBODIMENTS

Referring to drawings, an embodiment of the present invention is described below.

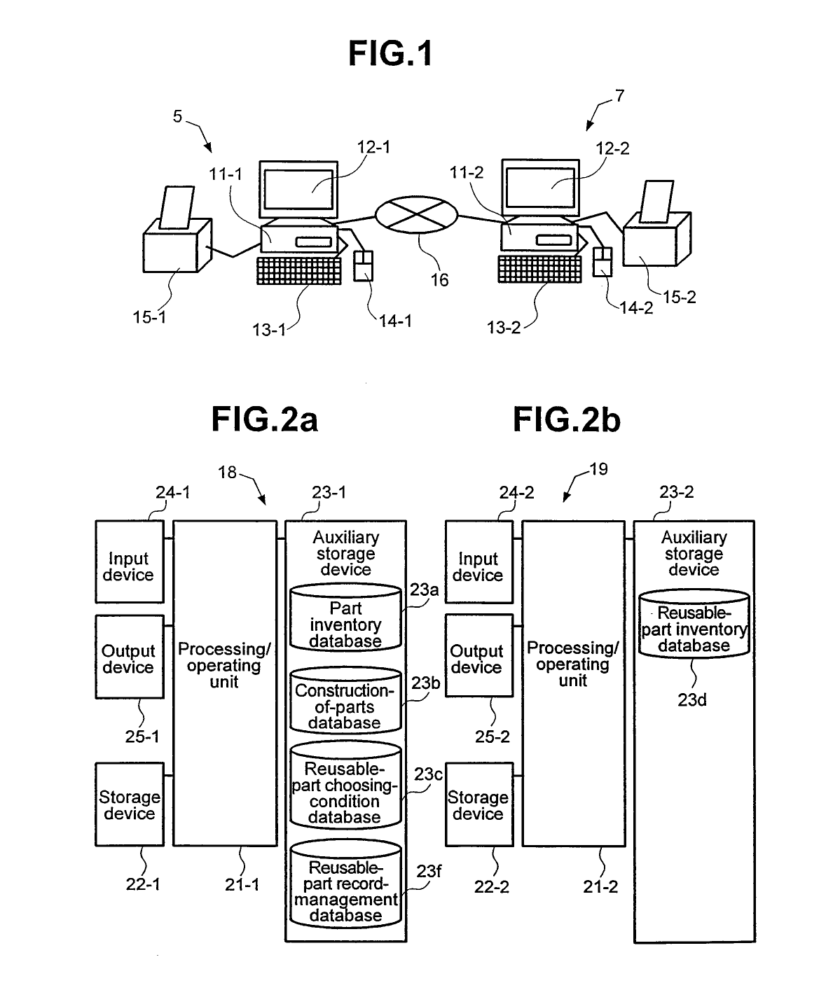

FIG. 1 shows the configuration of a system of an embodiment of the present invention.

A system of this embodiment comprises operational units 11-1 and 11-2, such as personal computers, display devices such as displays 12-1 and 12-2, and input devices such as keyboards 13-1, and 13-2 and mice 14-1, and 14-2. In addition, the following devices may be used: a network 16 such as the Internet to connect traders concerned, devices installed in the operational units 11-1/-2 to provide for connection to the network 16, and devices to read external storage media such as floppy disk drives, CD drives, DVD, Zip, Jazz, and MO (Magneto-optical) drives installed in the operational units 11-1/-2. If printers 15-1/-2 are used in addition to the displays 12-1/-2, results can be seen in a printed form. In FIG. 1, one set of such devices is for a user of reusable parts 5; the other, for a supplier of reusable parts 7, and the two sets of devices are connected to each other by the network 16. Although these devices are connected to one another by wires in FIG. 1, they may otherwise be connected to one another, for example optical fiber or a wireless connection. In other embodiments, in addition to one user of reusable parts 5 and one supplier of the same 6 being connected to each other, a plurality of user or supplier parties may be on one side or the other or on both sides.

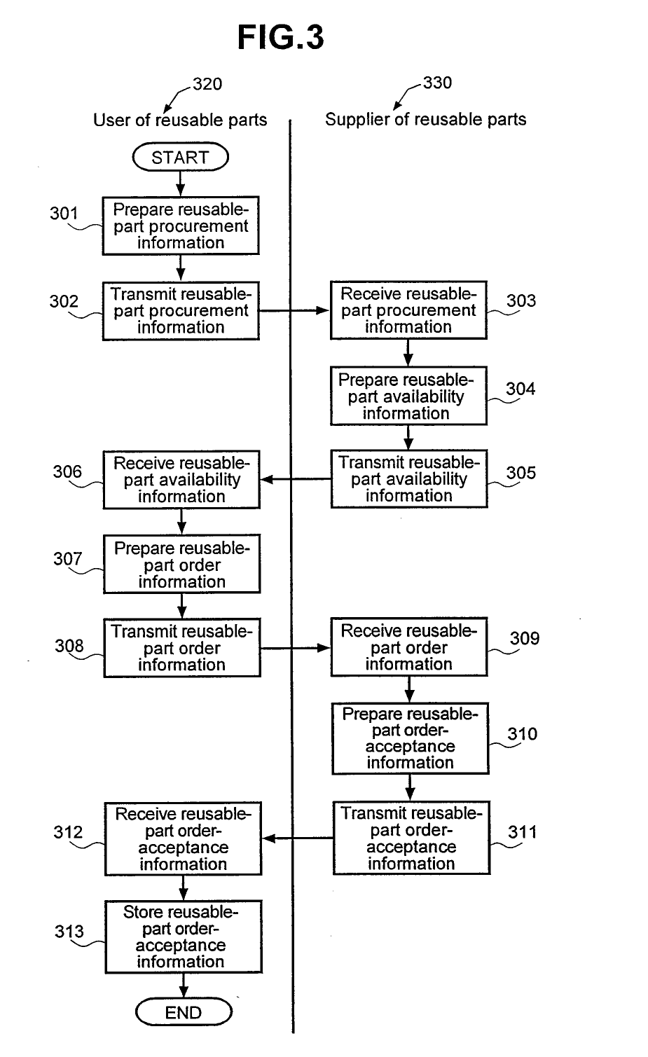

FIG. 2a shows an example of system configuration for the user of reusable parts 18 in one embodiment of the present invention; FIG. 2b, shows an example of system configuration for the supplier of reusable parts 19 in one embodiment of the present invention.

The system for the user of reusable parts 18 comprises a processing/operating unit 21-1 such as a CPU for personal computers, a storage device 22-1 such as a semiconductor memory, an auxiliary storage device 23-1 such as a hard drive, and an input device 24-1 and an output device 25-1 of which examples are shown in FIG. 1. The auxiliary storage device 23-1 comprises a part inventory database 23a to record parts in stock, etc., a construction-of-parts database 23b to store the construction of products, etc., a reusable-part choosing-condition database 23c, and a reusable-part record-management database 23f.

The system for the supplier of reusable parts 19 comprises a processing/operating unit 21-2 such as a CPU for personal computers, a storage device 22-2 such as a semiconductor memory, an auxiliary storage device 23-2 such as a hard drive, and an input device 24-2 and an output device 25-2 of which examples are shown in FIG. 1. The auxiliary storage device 23-2 comprises a reusable-part inventory database 23d to record reusable parts in stock, etc.

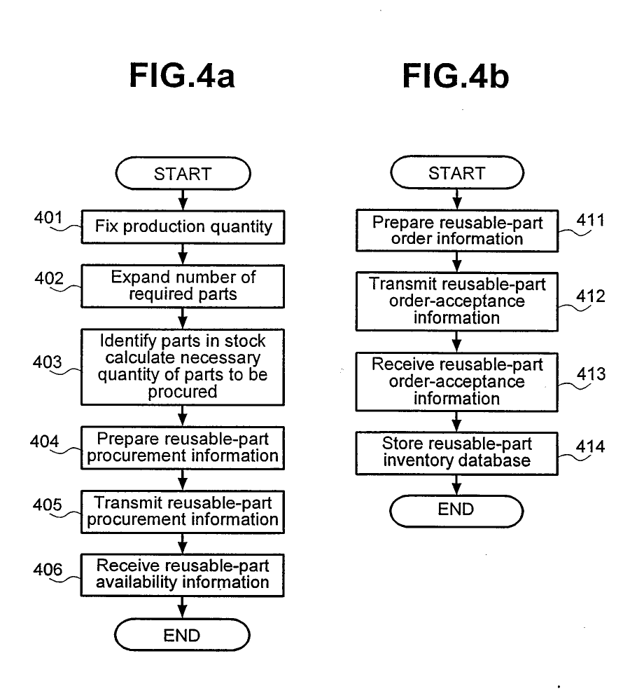

FIG. 3 shows an overview of the whole process of the system of an embodiment of the present invention.

The user of reusable parts 320 prepares reusable-part procurement information in Step 301 and transmits the reusable-part procurement information to the supplier of reusable parts 330 in Step 302. The transmission in Step 302 is done by well-known methods used in business transactions, including, for example, the use of the Internet.

In Step 303, the supplier of reusable parts 330 receives the reusable-part procurement information which was transmitted by the user of reusable parts 320 in Step 302. Pieces of reusable-part procurement information transmitted in Step 302 may be received in real time or in a batch mode by checking to see if there are any information files transmitted in Step 302.

In Step 304, the supplier of reusable parts searches the information on reusable parts in stock based on the reusable-part procurement information and prepares reusable-part availability information. In Step 305, the supplier of reusable parts transmits the reusable-part availability information to the user of reusable parts who transmitted the reusable-part procurement information in Step 302.

In Step 306, the user of reusable parts receives the reusable-part availability information transmitted by the supplier of reusable parts in Step 305. In Step 307, the user of reusable parts determines which parts to procure based on the reusable-part availability information and prepares reusable-part order information. In Step 308, the user of reusable parts transmits the reusable-part order information to the supplier of reusable parts who transmitted the reusable-part availability information in Step 305.

In Step 309, the supplier of reusable parts receives the reusable-part order information transmitted by user of reusable parts in Step 308. In Step 310, the supplier of reusable parts accepts the order based on the reusable-part order information and prepares order-acceptance information. In Step 311, the supplier of reusable parts transmits the reusable-part order-acceptance information to the user of reusable parts who transmitted the reusable-part order information in Step 308.

In Step 312, the user of reusable parts receives the reusable-part order-acceptance information transmitted in Step 311. In Step 313, the user of reusable parts stores and manages the reusable-part order-acceptance information.

As described above, in FIG. 3, information on necessary parts is extracted in Step 301, reusable parts in stock are checked for the demanded reusable parts in Steps 302-306, the contents of an order are determined based on the information on relevant reusable parts in stock in Step 307, the order is placed and accepted in Steps 308-310, and the order and its acceptance is confirmed in Steps 311-313.

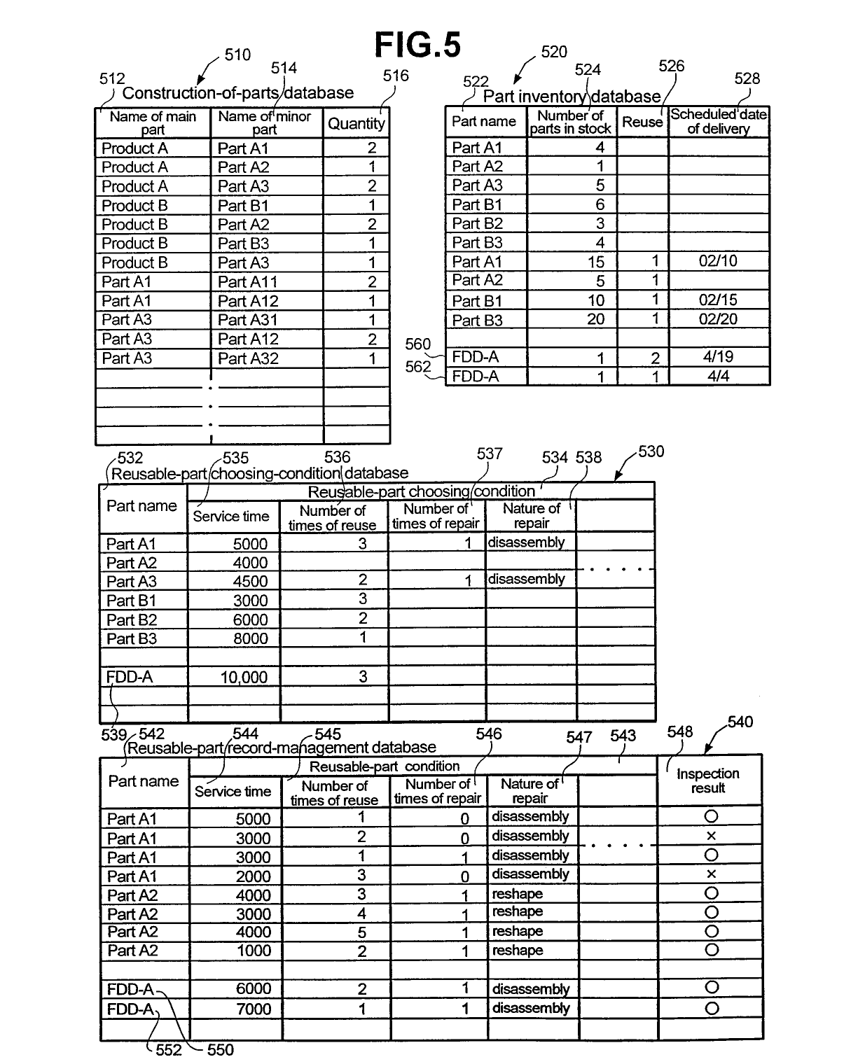

Referring to FIG. 4, the process on the side of the user of reusable parts 320 shown in FIG. 3 will now be described in details.

Referring to FIG. 4a, the detailed process on the side of the user of reusable parts 320 corresponding to Steps 301-306 will be described below.

In Step 401, the production quantities of products are fixed. Such production quantities are fixed by ordinary production planning. Accordingly information on fixed production quantities of products may simply be predetermined in Step 401.

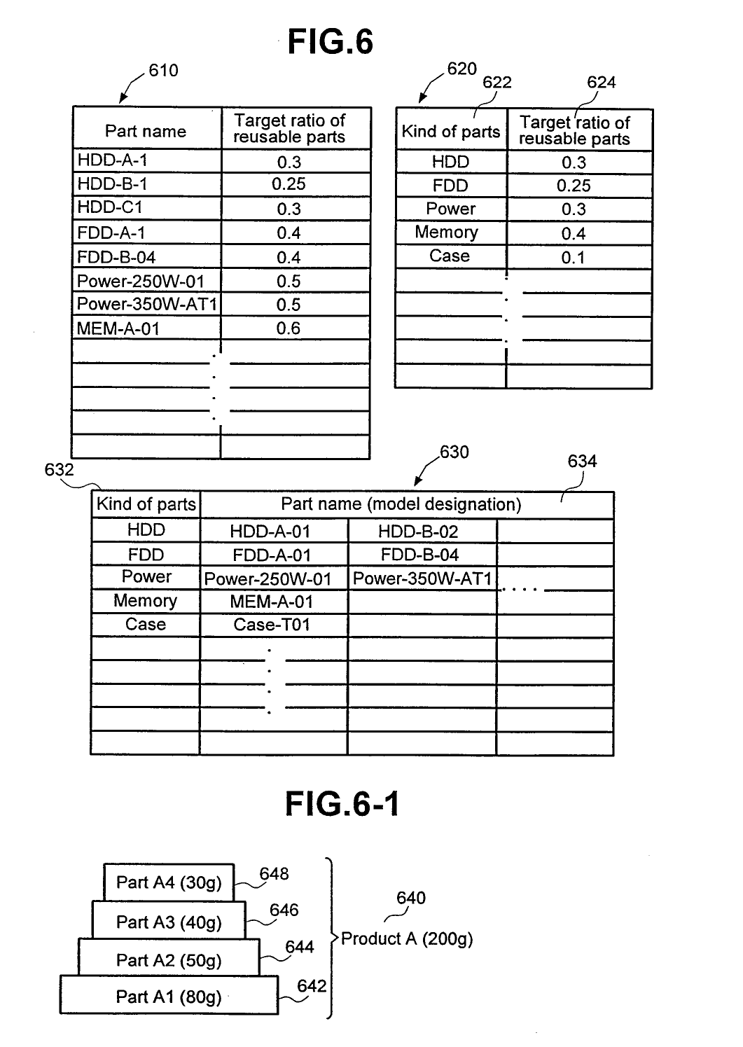

In Step 402, the necessary parts are identified based on the production quantities of products fixed in Step 401 and the construction-of-parts database 23b, of which an example 510 is shown in FIG. 5. The names of products and parts are described in the first column 512 of table 510. The names of component parts of each product or part in the first column 512 are described in the second column 514. The quantity of each component part in the second column 514 required by the corresponding product or part in the first column is described in the third column 516. If “a” units of a product “A” is required, the first column 512 is searched for the product “A” and the names and the quantities of parts required for one unit of the product “A” are extracted from the second 514 and third columns 516.
Required quantity of each part=quantity of said part used in one unit of a product×production quantity of the product [Equation 1]

By using equation 1, the necessary quantity of each part constituting the product “A” is calculated. Then the column 1 512 of table 510 is searched for a part “A1”, for example, and the names “A11” and “A12” and the quantities of component parts required for one unit of the part “A1” are extracted. For example two part “A11” and one part “A12.”
Required quantity of each component part=quantity of said component part used in one unit of a part×required quantity of the part [Equation 2]

By using equation 2, the necessary quantity of each component part constituting, for example, the part “A1” is calculated.
Required quantity of each terminal component part=π(quantity of said terminal component part used in one unit of a part×required quantity of the part) [Equation 3]

π: Repeated multiplication from the product to its terminal component parts

By iteratively repeating the calculation with equation 3, the quantity of each terminal component part required for the production of the fixed quantity of each product is calculated. By adding up the quantity of each terminal component part required for the production of the fixed quantity of each product through all the products, the quantities of all the terminal component parts required for the production of the quantities of all the products fixed in Step 401 are found. The above calculation of the required numbers of terminal component parts is usually made by an ordinary production-planning system.

In Step 403, parts to be procured are identified based on the required quantities of parts and the parts inventory database 23a shown in table 520 in FIG. 5. The first 522 and second 524 columns of table 520 hold the names and the quantities of parts in stock. If the required quantity of a part “A2” is “b” in Step 402, the first column 522 is searched for the part “A2” and the quantity of the part “A2” in stock is extracted for column 524.
Quantity of each part to be procured=required quantity of said part−quantity of said part in stock [Equation 4]

By using equation 4, the quantity of each part to be procured is calculated. Such quantity of each part may be calculated by taking the quantity of spares of said part into account. Such calculation can be made by an ordinary production planning system. It should be noted that any code identifiable of a specific part such as “drawing No. of part” or “model designation of part” may be used in place of “part name” used herein.

In Step 404, prepared based on the quantities of parts to be procured calculated in Step 403 is reusable-part procurement information on the part names (in an alternative embodiment of the system, model designations, part Nos., or the like may be used instead of part names) and the quantities of reusable parts to be procured and other matters. Unlike new, or unused, parts, each reusable part has its own unique service history. Therefore, each of reusable parts even with one and the same part name (or of one and the same model designation) has to be handle differently from the others. If reusable parts are procured in the same way as new parts [which are procured by part name (or model designation), quantity, date of delivery, etc.], reusable parts with specifications (for example, service time in the past) required by the user of reusable parts cannot necessarily be procured. Accordingly, at the time of transmission of reusable-part procurement information which is prepared in Step 404 to include model designations such as “part A1”, quantities, dates of delivery, etc., information on the history and the conditions of past reuse of each reusable part such as service time in the past, number of times of reuse in the past, number of times and nature of repair, etc. has to be transmitted too. Conditions for choice of reusable parts usually differ among kinds or model designations (names) of parts and are managed by the reusable-part choosing-condition database 23c. FIG. 5 table 530 shows an example of the reusable-part choosing-condition database 23c. As shown in the figure, the first column 532 holds part names and the second column 534 holds reusable-part choosing conditions. For example, information such as service time in the past 535, number of times of reuse in the past 536, number of times 537 and nature of repair 538, etc. of each reusable part is entered in the second column 534. It is not necessarily required to manage all the choosing conditions for each reusable part. If a mechanical part has moving part, it may be managed by “service time” (information on service time alone is entered). If a part is used to join and tighten two or more parts and its life depends on the number of times of use, it is managed by the number of times of use. If the life of a part is influenced by the number of times and the nature of repair, it is managed by such indexes. In this way, it is important to set appropriate conditions for each part.

As conditions for choice, service record (the service time of a product in which a reusable part was fitted) and trouble record of reusable parts in the past may be managed.

The reusable-part procurement information to be prepared in Step 404 is not necessarily required to carry the whole quantity of each part calculated in Step 403. The target ratio of the number of reusable units to the number of all units, for example, both reusable and new units, required may be predetermined for each part.
Number of reusable units to be procured=number of all units of each part to be procured×target ratio of reusable units [Equation 5]

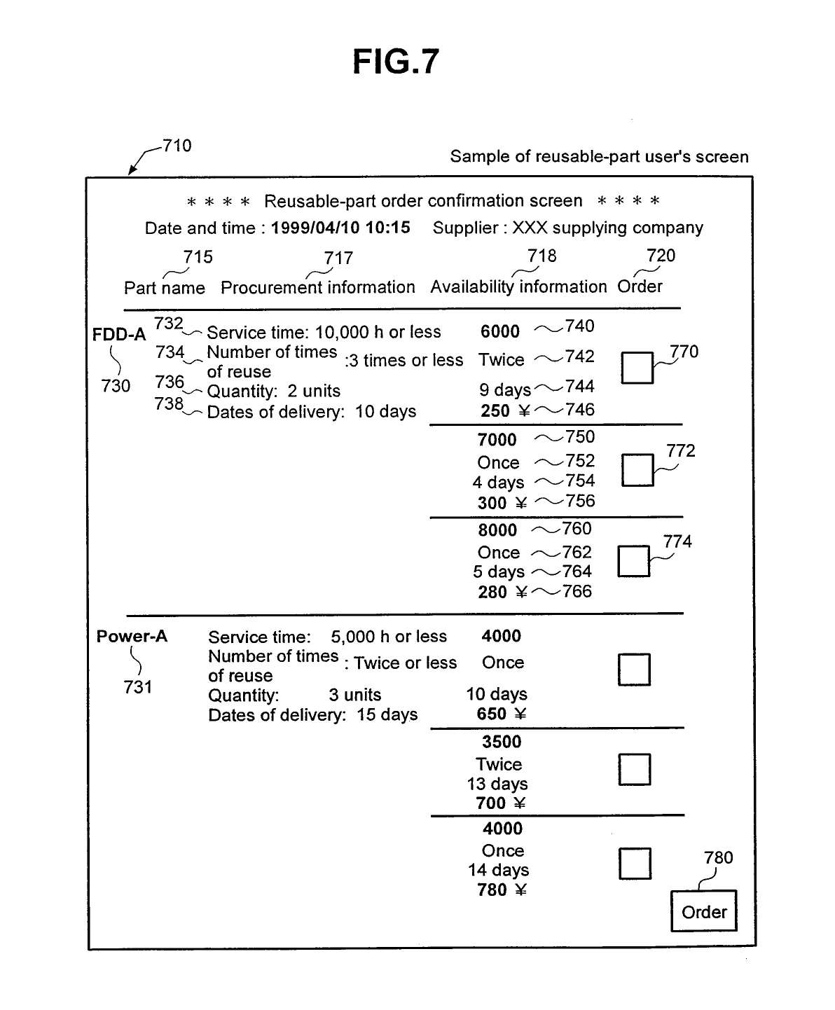

By using the above Equation 5, the number of reusable units to be procured can be calculated. The target ratio of reusable units can be managed by a reusable-unit target-ratio database (located, but not shown, in Auxiliary storage device 23-1 of FIG. 2a). Examples are of the database are illustrated in tables 610 or 622 of FIG. 6. Although the target ratio is managed by part names in FIG. 6 table 610, it may be managed by the kinds of parts as shown in FIG. 6 table 620. In the latter case, a kinds-of-parts database 23h, which relates part names 634 to kinds of parts 632 as shown in FIG. 6 table 630 is provided. The second column 634 is searched for a certain part. When it was found, its kind is determined in the first column 632. Then the first column 622 of the reusable-unit target-ratio database (e.g. table 620) is searched for the kind of parts. When it was found, its target ratio 624 is determined in the second column for the application to Equation 5.

Based on the information of the reusable-part record-management database 23f, etc., the inspection records of each part (or each kind of parts) may be added up, and its result may be used in the equation below.

$$Number of reusable units to be procured = \\ number of all units of each part to be procured \times \\ ( 1 / \frac{number of non \text{-} defectives procured in the past}{\begin{matrix}number of all units of each \\ part procured in the past\end{matrix}} ) \qquad [ Equation 6 ]$$

By using the above Equation 6, it is possible to allow for defectives.

The numbers of all new units and all reusable units of each part procured in the past can easily be obtained by adding up the information in the first and third columns of the reusable-part record-management database 23f. It is not necessarily required to add up all the information in the past. Instead, the information in a certain period of time or the information on a certain quantity of each part may be added up. Besides, information on the suppliers of reusable parts may be added to the reusable-part record-management database 23f, and if data on the units of a reusable part procured from a specific supplier are used in Equation 6, the calculation becomes more accurate. The procurement record of new units of each part may be stored in a database, and the database may be used together with the reusable-unit target-ratio database for the calculation with the equation below.
Number of reusable units of each part to be procured=(number of reusable units of said part procured in the past+number of new units of said part procured in the past+number of all units of said part to be procured)×target ratio of reusable units to all units of said part−number of reusable units of said part procured in the past [Equation 7]

By calculating the number of reusable units to be procured every time with the above Equation 7, the ratio of reusable units to all units of each part can be brought close to the target ratio in the reusable-unit target-ratio database. Of course, Equations 5, 6, and 7 can be combined and used.

When these equations are used, calculated values will not necessarily be integers. The fractions of such non-integral values may be rounded up, off, or down. Although FIG. 6 shows the target ratio of reusable units for each part is shown, a target ratio may be set for each product, and a single ratio for all the parts constituting said product may be calculated with the above equations.

FIG. 6-1 shows an example of the target weight ratio for each product, or each kind of products, or each place of production. As shown in FIG. 6-1, a product A (weight 200 g) 640 consists of a part A1 (weight 80 g) 642, a part A2 (weight 50 g) 644, a part A3 (weight 40 g) 646, and a part A4 (weight 30 g) 648. The target weight ratio of reusable units to all units of the product A is, for example, 30%. If five units of the product A are produced, five units of each of the parts A1 to A4 are necessary. The weight of the five units of the product A is 1,000 g. To achieve the target weight ratio of 30%, 300 g of reusable units have to be used as represented by the equation below. In one embodiment all five products A have substantially the same weight and different combinations of reusable parts for parts A1 to A4 are chosen to meet the target weight ratio.
Weight of part A1×number of reusable units of part A1 to be procured+weight of part A2×number of reusable units of part A2 to be procured+weight of part A3×number of reusable units of part A3 to be procured+weight of part A4×number of reusable units of part A4 to be procured≧gross procurement weigh(=weight of product A×production quantity)×target weight ratio of reusable units [Equation 8]

As the above Equation 8 does not bring about a unique solution, the parts A1 to A4 have to be weighted by the records of procurement and use of their reusable units in the past and the prices of their reusable units so that the numbers of their reusable units to be procured can be determined effectively.

Although Equation 8 defines the target weight ratio of one-time procurement, Equations 6 and 7 may be applied to the target weight ratio here to take account of the actual results of procurement and use of the parts in the past in calculating the weight ratio. The target weight ratio may be applied to each kind of products or each place of production.

As the result of the utilization of the reusable-part choosing-condition database 23c, the reusable-part procurement information to be prepared in Step 404 includes reusable-part choosing-condition information such as, for example, user names of reusable parts, user codes, model designations (names) of reusable parts, quantities required, dates of delivery, service time in the past, number of times of reuse, etc. In addition, suggested purchase prices may be included in the information. By including in the information a flag to distinguish the transmission of the reusable-part procurement information in Step 405 (inquiry about inventory, for which the flag is, for example, “0”) from the transmission of the reusable-part order information in Step 412 (placing a firm order, for which the flag is, for example, “1”), inquiry about inventory and placing a firm order can be made in one and the same format and, thus, the system becomes easy to operate and the man-hours necessary to develop the system decreases. The flag enables the supplier of reusable parts to distinguish an inquiry from a firm order easily. When an inquiry was received, the inventory is checked in accordance with Steps 801 to 805, which will be described later. When a firm order is received, it is processed in accordance with Steps 811 to 815, which will be described later.

Regarding the format to record the above information, a file wherein items are divided by delimiters such as commas or tabs (so-called “CSV file” or “tab-divided file”) may be used, or the information may be written in the XML (eXtensible Markup Language).

In Step 405, the reusable-part procurement information prepared in Step 404 is transmitted to the supplier of reusable parts. The reusable-part procurement information may be transmitted through the Internet or by the well-known methods used in the existing business transactions. For example, the user of reusable parts many store the address of the addressee in a database every time reusable-part procurement information is transmitted and the reusable-part procurement information prepared in Step 404 may be transmitted by using the FTP (File Transfer Protocol) or the like.

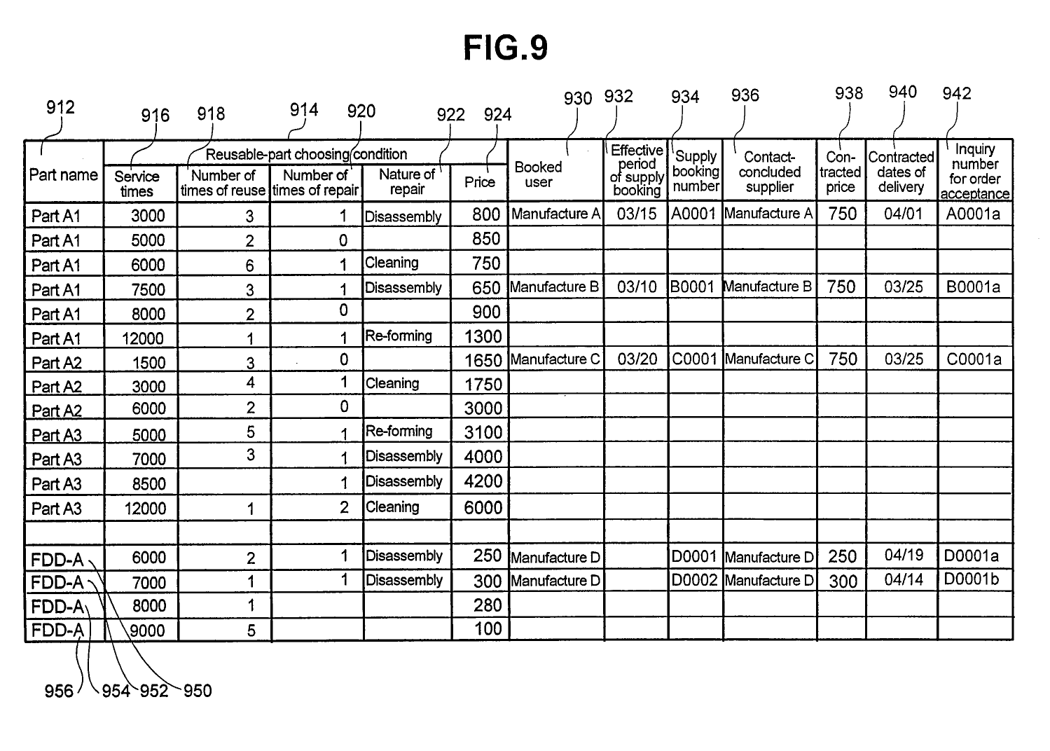

According to the reusable-part procurement information, the supplier of reusable parts searches its inventory data for data on the demanded reusable parts and transmits reusable-part availability information to the user of reusable parts. The method for the processing here will be described later by referring to FIG. 8a.

The user of reusable parts receives the reusable-part availability information from the supplier of reusable parts (Step 406). The reusable-part availability information includes the supplier's name or code, part names, service times and numbers of times of reuse in the past, dates of delivery, prices, and offer information number. The details of the reusable-part availability information will be described later. The format of the reusable-part availability information and the method of transmitting and receiving the information are similar to those used in Steps 404 and 405.

Referring to FIG. 4b, the processing in Steps 307 to 313 by the user of reusable parts will now be described.

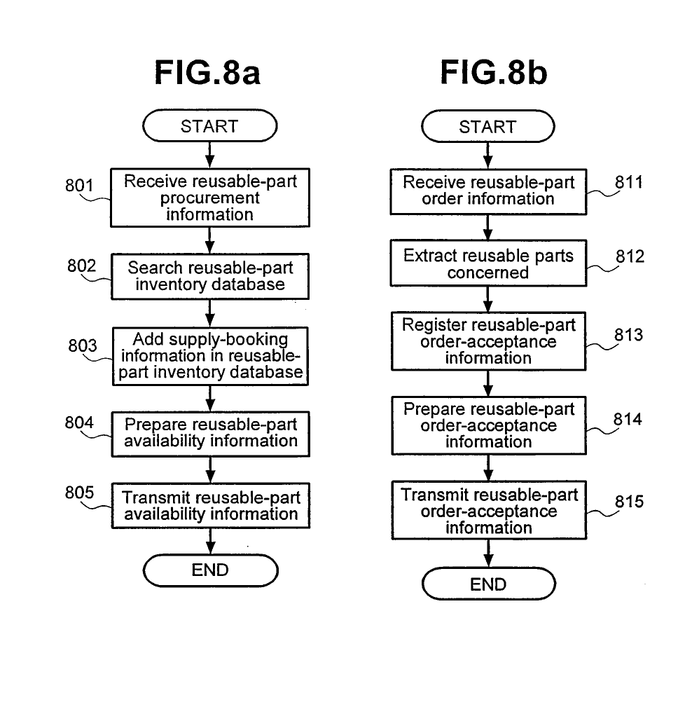

In Step 411, the user of reusable parts places an order with the supplier of reusable parts by preparing reusable-part order information based on the reusable-part availability information received in Step 406 and transmitting it to the supplier of reusable parts (Step 412). If the reusable-part availability information is in accord with the reusable-part procurement information, the order may be placed unconditionally. Alternatively, such information as shown in FIG. 7 may be presented to the user of reusable parts to entrust the judgment to a manager. In FIG. 7, the reusable-part procurement information transmitted from the user of reusable parts, e.g., 730 and 731, and the reusable-part availability information transmitted from the supplier of reusable parts, for example, 740, 742, 744, 746, 750, 752, 754, 756, and 760, are displayed on a screen, and the manager compares them, puts a check mark in the order boxes, for example, 770, 772, and 774, of reusable parts which he approves, and push the “confirmation button 780. Thus, reusable-part order information is prepared. The reusable-part order information includes dates of delivery, prices, and the offer information number of the reusable-part availability information as well as information similar to the reusable-part availability information. By transmitting the reusable-part order information together with the offer information number to the supplier of reusable parts, the supplier of reusable parts can easily relate the reusable-part order information to the parts in stock from which the reusable-part availability information was originated. Thus the processing of the reusable-part order information becomes easy. The processing on the side of the supplier of reusable parts will be described later. In the example of FDD-A 730 in FIG. 7, two units 736 are demanded by the user, whereas three units are offered by the supplier (e.g., 770, 772, and 774). When such a case occurs while orders are being placed automatically (a screen shown in FIG. 7 does not necessarily have to be displayed), parts can be chosen and reusable-part order information can be prepared automatically through the functions of an ordinary information system if such conditions are set in advance as “lower price,” “shorter service time,” or “smaller number of times of use.” Even when orders are placed by a worker, parts can be chosen efficiently if parts are arranged in the order of priority based on such conditions.

In an embodiment where for reusable parts, both the “service time” and the “number of times of reuse” matter, a “reusable-part margin” may be used as follows.
Reusable-part margin=min.[(upper limit on past service time/past service time−1),(upper limit on number of times of reuse/number of times of reuse−1)] [Equation 9]

It is effective to choose reusable parts with large margins.

In Step 412, the supplier of reusable parts receives the reusable-part order information from the user of reusable parts, searches the inventory information for the demanded reusable parts, and transmits reusable-part order-acceptance information to the user of reusable parts. The method for the processing here will be described later by referring to FIG. 8a.

The user of reusable parts receives the reusable-part order-acceptance information from the supplier of reusable parts (Step 413) and stores the reusable-part order-acceptance information as reusable-part contract-conclusion information in the part inventory database 23a (Step 414). The third column of the part inventory database 23a is allocated to “scheduled date of delivery” as shown in FIG. 5 table 520, and the dates of delivery in the reusable-part order-acceptance information are extracted and stored in the third column of the part inventory database 23a. A device is built in an inventory management system so that the ordered reusable parts can be added to the inventory upon their delivery to the user of reusable parts. The above processing can be accomplished by a system similar to an ordinary inventory management system for new parts. Although the method of transmitting and receiving data in Step 413 is the same as that described earlier, it is effective for the reusable-part order-acceptance information to include the supplier name and an inquiry number to facilitate dealing with inquiries in addition to information on the ordered reusable parts.

It is not necessarily required to follow all the steps shown in FIG. 4. For example, if there is a large quantity of a reusable part in stock, Steps 404 to 406 may be skipped over and the reusable part may be procured by making the ordering processing from Step 411 onward. If the demand for reusable units of a part is not fully covered by the offer of the first supplier, the processing from Step 405 onward may be made to another supplier for the shortage. In this case, a database storing the addresses (for example, IP addresses to which FTP is transmitted) of two or more suppliers of each reusable part is provided. A method of transmitting reusable-part procurement information to two or more suppliers and procuring from the best supplier will be described later. If the shortage is not fully made up by suppliers, the final shortage has to be covered by new units of the part.
Necessary number of new units of each part=necessary number of said part−ordered number of reusable units of said part [Equation 10]

(The “ordered number of reusable units of said part” is the quantity in the reusable-part contract-conclusion information in Step 414.) The necessary number of new units of each part calculated by the above Equation 10 is fed to an ordinary new-part procurement system.

The construction-of-parts database 23b of which an example is shown in FIG. 5 table 510, the part inventory database 23a of which an example is shown in FIG. 5 table 520, and the reusable-part choosing-condition database 23c are not necessarily required to have the same construction so long as they include similar data items. Besides, ordinary methods can be used to search these databases and extract data from them.

In FIGS. 4 and 5, the user of reusable parts is assumed to be a manufacturer. However, other embodiments may include other types of users. If the user of reusable parts is a firm which undertakes the regular maintenance of products and parts or a firm which undertakes the repair of products and parts, necessary parts and their necessary quantities are determined from parts to be maintained or repaired and their quantities, instead of products to be manufactured, in Steps 401 and 402. Other steps in FIGS. 4 and 8 are applicable to such a user of reusable parts without any change.

With the process shown in FIGS. 4 and 5, the user of reusable parts can easily procure reusable parts meeting conditions in necessary quantities and smoothly manufacture products, or maintain or repair products and parts.

Referring to FIG. 8a, the processing to extract information on availability of reusable parts in the process of checking the inventory from Step 302 to Step 306 will be described below.

In Step 801, the supplier of reusable parts receives the reusable-part procurement information transmitted by the user of reusable parts in Step 405. The transmitting and receiving method here is the same as that described earlier by referring to FIG. 4.

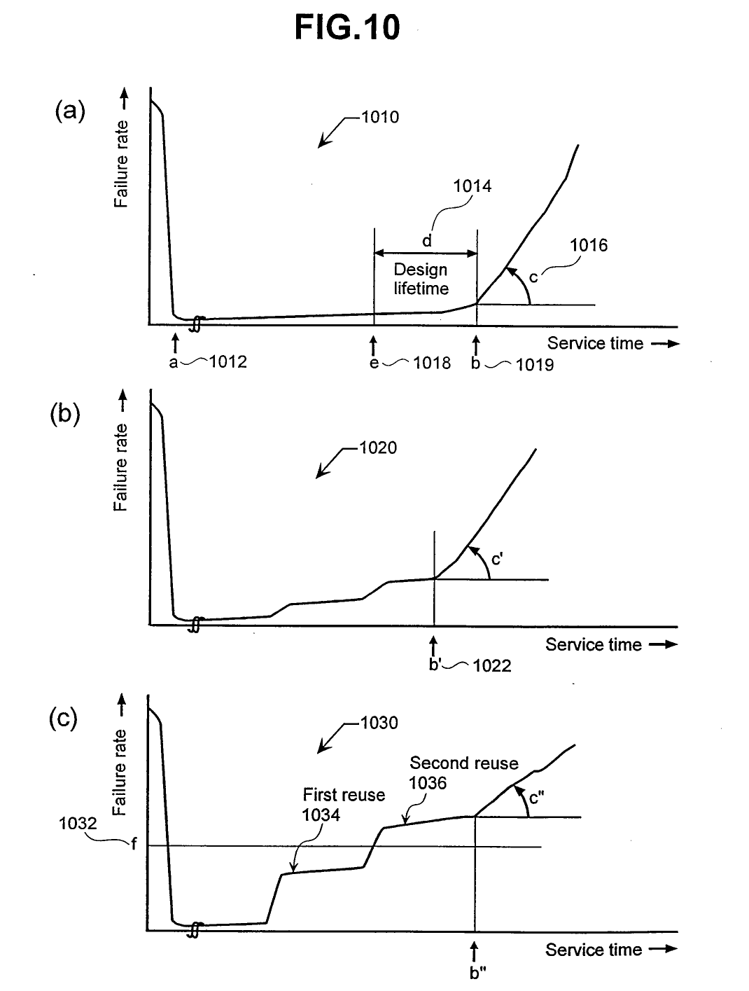

In step 802, the reusable-part choosing conditions such as part name, required quantity, date of delivery, service time in the past, and number of times of reuse in the past all contained in the reusable-part procurement information are used to search the reusable-part inventory database 23d for the demanded reusable parts. FIG. 9 shows an example of the reusable-part inventory database 23d. As shown in FIG. 9, the first column 912 of the reusable-part inventory database 23d holds part names. The second column 914 holds information with respect to the reusable-part conditions such as service times 916, numbers of times of reuse 918, and natures 922 and numbers of times 920 of repair of individual parts in the past (the items in second column 914 are examples of the individual history for each individual reusable part). The third column 924 holds prices of individual parts. Search conditions are set in advance. For example, these data are searched for parts which meet the requirements of the reusable-part procurement information. Search is conducted for parts which have the exactly same names as the parts in the reusable-part procurement information and service times and numbers of times of reuse in the past less than those in the reusable-part procurement information. In this way, parts meeting all the conditions are extracted. In case that two or more parts are extracted for one part in demand, they are prioritized based on such conditions prescribed in advance as lower (or higher) price, longer (or shorter) service time in the past, and smaller (or larger) number of times of reuse in the past. Thus, reusable parts can be offered efficiently. The above search can be performed with an ordinary database and its searching, sorting, and extracting system.

In FIG. 9, the fourth 924, fifth 932, and sixth 934 column of the reusable-part inventory database 23d hold booking information on reusable parts extracted by the above search. As shown in FIG. 4, the user of reusable parts inquires about availability of reusable parts, receives information on available reusable parts in Step 404 to 406, and places an order for available reusable parts in Step 411 to 413. When reusable parts meeting the requirements of the reusable-part procurement information are found in the reusable-part inventory database 23d, booking information (booked user, effective period of booking, etc.) is recorded in the fourth 924, fifth 932, and sixth columns 934 of the database 23d. The reusable parts of which the booking is effective are excluded from the inventory. Thus the user of reusable parts booked in the reusable-part inventory database 23d is given priority for ordering the reusable parts booked in the database. When the booking of any parts expires, they are returned into the inventory. The grant of the priority is optional.

Reusable-part choosing conditions can be different among different kinds of parts. Besides, it is not necessarily required to effect all the conditions. The service times, numbers of times of reuse, numbers of times of repair of individual reusable parts can be managed by the “service system for information on individual products and parts in product life cycle” disclosed in Japanese Unexamined Patent Publication No. 10-222568, or the managing system of the histories of individual parts for supporting the recycling of parts in Development of Information System for supporting inverse manufacturing, the Proceedings of Japan Conference 1999 of Precision Engineering Society of Japan, or the like.

In Step 803, the booking information on the reusable parts extracted in Step 802 are entered in the fourth 930, fifth 932, and sixth 934 columns of the reusable-part inventory database 23d. The name or code of the user of reusable parts in the reusable-part procurement information received in Step 801 is entered in the fourth column 930; the date after a certain time period (fixed by a contract), in the fifth column 932; and information (for example, user code and a serial number or a supply booking number) to identify each booking, in the sixth column 934.

In Step 804, reusable-part availability information is prepared for the reusable parts which were extracted in Step 802 and allotted booking numbers in Step 803. The reusable-part availability information comprises the name or code of the supplier and the names, service times and numbers of times of reuse in the past, dates of delivery, prices, booking numbers, and effective periods of booking of available reusable parts. In Step 805, the reusable-part availability information is transmitted to the user of reusable parts who transmitted the reusable-part procurement information to the supplier of reusable parts in Step 801. The reusable-part availability information is received by the user of reusable parts in Step 406. The transmitting and receiving method is the same as those described earlier. Because booking numbers are transmitted together with reusable-part availability information, it is important to relate the booked parts to the order acceptance in Step 812.

Referring to FIG. 8b, the processing of order acceptance of reusable parts in the process of order and order acceptance of reusable parts from Step 308 to Step 312 will be described below.

In Step 811, the reusable-part order information transmitted in Step 412 is received. The reusable-part order information includes such information as part names, prices, dates of delivery, and booking numbers. By using the information, the reusable-part inventory database 23d is searched for the ordered parts in Step 812. Their order-acceptance information is registered in Step 813. Reusable-part order-acceptance information on them is prepared in Step 814 and transmitted to the user of reusable parts in Step 815. The reusable-part order-acceptance information is received by the user of reusable parts in Step 413.

The processing from Step 812 to Step 814 is made for all the ordered reusable parts. In Step 812, the ordered reusable parts can be extracted by searching the reusable-part inventory database 23d for them based on the part names and the booking numbers. This search key depends on the construction of the booking number determined in Step 803. If the booking number consists of the booked part number and a serial number, the search is made with the booked part number and the serial number. If the booking number is a serial number, the search is made with the serial number. If the booking number consists of the booked user name and a serial number, the search is made with the booked user name and the serial number. In this way, the search in Step 812 can be performed by making use of the booking number fixed in Step 803. In Step 813, inquiry numbers or the like are entered in the tenth column 942 in addition to the names or the codes of users of reusable parts in the seventh column 936, contracted prices in the eighth column 938, and dates of delivery in the ninth column 940. Reusable-part order-acceptance information including the name or the code of the supplier of reusable parts, the names of the contracted reusable parts, the amount of order acceptance, the dates of delivery, and an inquiry number is prepared in Step 814 and transmitted to the user of reusable parts in Step 815. The transmitting and receiving method is the same as those described earlier.

Although the shipping information on contracted parts should be managed in the reusable-part inventory database 23d, such information can be managed in the same way as ordinary inventory management information on new parts. To delete inventory information on a part in the reusable-part inventory database 23d, the line of the part may be deleted or a flag indicating the conclusion of a contract (or shipment) may be put up on the line of the part. By either method, the inventory can be managed. The latter method is better, however, in order to cope with the changes of contracts or manage the records of shipment.

It is important for the supplier of reusable parts to manage individual units of parts by allotting one line to each unit in the reusable-part inventory database 23d as shown in FIG. 9 if there are two or more units of one and the same part in the inventory because each unit has its own unique history. However, some kinds of parts may not require one-unit-per-one-line management. In this case, the information on individual units in the second column 914 of FIG. 9 is unnecessary.

The reusable-part inventory database 23d, of which an example is shown in FIG. 9, is not necessarily required to have the construction shown in FIG. 9 so long as the database includes the similar data items. Besides, ordinary searching and extracting method can be applied to the reusable-part inventory database 23d.

With the process of FIG. 8b, the supplier of reusable parts can easily extract the reusable parts required by the user of reusable parts from the inventory and hence can easily provide the user with reusable parts.

The method of setting conditions in the second column of the reusable-part choosing-condition database 23c, of which an example is shown in FIG. 5 table 530, will be described below.

The user of reusable parts operates a reusable-part record-management database 23f, of which an example is shown in FIG. 5 table 540. The first column 542 of table 540 holds part names; the second column 543, reusable-part conditions (including data on histories of reusable parts such as service time 544, number of times of reuse 545, and repair 546 and 547); and the third column 548, inspection results of reusable parts.

Upon the procurement of reusable parts from the supplier of reusable parts, the user of reusable parts records the names and the choosing conditions of the reusable parts and the results of inspection of them by the user's inspection standard. Although inspection results are indicated by “O (non-defective)” and “X (defective),” more detailed management may be made by using, for example, “* (usable in products),” “O (usable as maintenance parts),” and “X (unusable).” Although reusable parts are managed by part names in the first column 542 in table 540, in other embodiments, they may be managed by entering kinds of parts (for example, hard-disk drive, power supply, mother board, etc.) in the first column 542, or by entering kinds of parts and manufacturers' names in the first column 542, or by entering kinds and specifications (for example, capacities) of parts in the first column 542, or by entering model years in addition to such items in the first column 542. The method described below is applicable to any of the above cases.

All units of each part are searched for in the reusable-part record-management database 23f.
Acceptable maximum past service time of each part=min.(past service times of defective units)−design life of said part−100 [Equation 11]

The acceptable maximum past service time of each part can be fixed by using the above Equation 11. The design life of each part is managed by a database for managing information on each kind of parts or each part and reference is made to the database.
Acceptable maximum number of times of past reuse of each part=min. (numbers of times of past reuse of defective units)−1 [Equation 12]

The acceptable maximum number of times of past reuse of each part can be fixed by using the above Equation 11. It should be taken into consideration that the conditions of units of each part vary and some units may be rejected at an exceptionally low level and that the user of reusable parts inspects procured reusable parts by its own standard. Accordingly, the acceptable maximum past service time of each part may be fixed by using, for example, a past service time by which 20% or more of the units of said part are rejected, and the acceptable maximum number of times of past reuse of each part may be fixed by using, for example, a number of times of past reuse by which 20% of more of the units of said part are rejected. The above shows examples of ways, practical choosing conditions can be set.

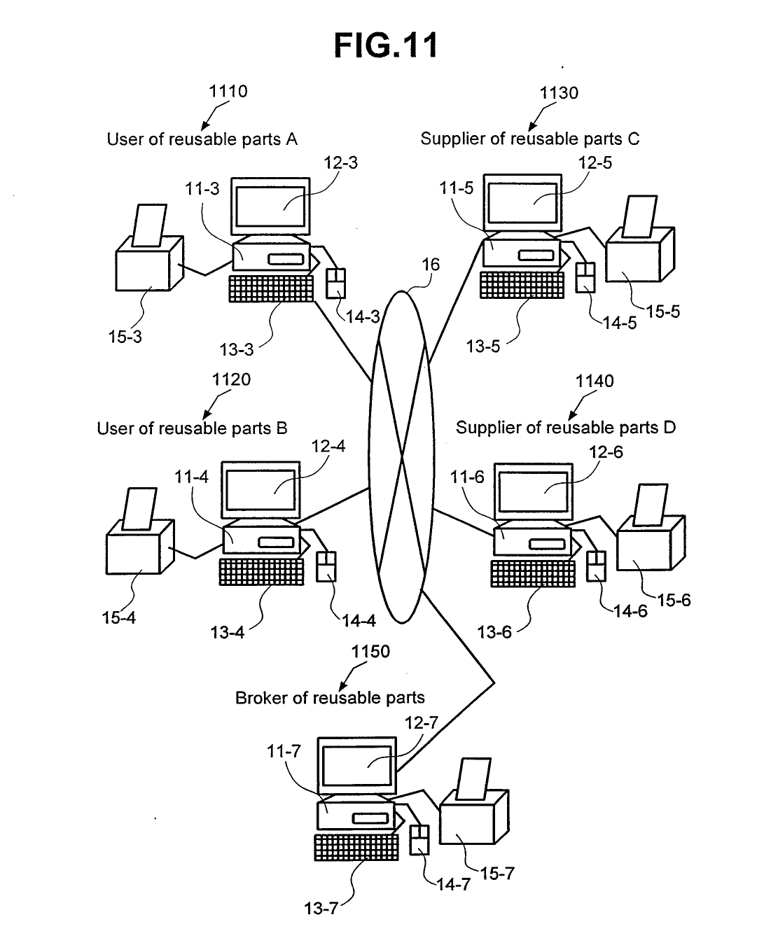

When information on defective units and non-defective units of each part accumulates, more practical choosing conditions can be set by using the following method. Generally speaking, the failure rate of a part changes as time passes as shown in FIG. 10 graph 1010. The initial peak is so-called “initial failure.” Any unit which survived the time period “a” 1012 has a very low failure rate. Its failure rate increases gradually due to aged deterioration. When it has been used beyond its design life, its failure rate increases rapidly because some component (for example, a capacitor) becomes liable to fail.

If we can identify the rapid increase of the failure rate of a part by the slope with “c” 1016 degree, the lifetime of the part (for example, “b” 1019) can be determined. By subtracting the actual service time of each unit of the part from the lifetime of the part, the lifetime of said unit as a reusable part, or unit, can be found. By using the information on such lifetimes of reusable parts, or units, the failure rate of a product in which a reusable part or parts are incorporated can be kept low. In FIG. 10 graph 1010, by subtracting the actual service time of each unit of the part from the lifetime “b” 1019 of the part, the lifetime of said unit as a reusable part, or unit, can be found. In this embodiment, the user of reusable parts can use the above lifetimes of reusable parts as a choosing condition. Thus, the failure rates of reusable parts can be predicted and reusable parts can be managed efficiently. Besides, by making use of the lifetime of a reusable part, the user of reusable parts can set the acceptable maximum past service time, a choosing condition, for the reusable part [FIG. 5 table 530, column 535], which brings about the same effect.

Moreover, by subtracting the design lifetime (predicted service time in case that the part is used for manufacture or maintenance) “d” 1014 from the lifetime of the part, b 1019, the past service time, “e” 1018, within which procurement is considered, is determined.
Acceptable maximum past service time of each part=service time of said part until failure rate begins to increase rapidly−design lifetime of said part

The design lifetime “d” 1014 shown in FIG. 10 graph 1010 of a part when it is used for the manufacture of products may differ from the design lifetime of the part when it is used for maintenance. Accordingly, in case of a part which is supposed to be used for both the manufacture of products and maintenance, values for manufacture and values for maintenance may be managed in a database and units for manufacture and units for maintenance may be procured under different conditions. This method can be applied not only to the management by parts but also to management by kinds of parts and management by the combinations of manufacturers and kinds of parts.

Although the service time of a part is shown in the example of FIG. 10 graph 1010, two or more conditions can be set appropriately if such information on actual results of parts as are shown in FIG. 10 graphs 1020 and 1030. In the example of graph 1020, each time a part is reused, its failure rate rises a little. It is expected that as the number of times of reuse increases, the lifetime of the part, “b′” 1022 in graph 1020 becomes shorter than the lifetime “b” 1019 in graph 1010. By using information on reuse histories of parts additionally, their failure rates can be predicted more accurately.

In the example of FIG. 10 graph 1030, the failure rate of a part rises steeply at each event such as reuse, and its failure rate exceeds the level, e.g., “f” 1032, required by the user of reusable parts. Thus, the failure rate of the part is heavily influenced by each event such as reuse. In the present embodiment, it is understood that the failure rate rises steeply at each event such as reuse, etc. and exceeds the “marginal failure rate” not by considering “angle c . . . ” but by combining conditions of “marginal failure f”. Accordingly the lifetime of reusable units of the part have to be set by events such as reuse (and presence or absence of repair history and, if presence, number of times of repair) instead of service time. The failure rate at the occurrence of each type of events may be examined, and units with a history of involvement in any type of events which reduces the ratio of non-defectives substantially may be precluded from consideration. For example, in graph 1030, a first reuse 1034 is acceptable, as it is below “f” 1032, but a second reuse 1036 will have the part excluded, as it is above “f” 1032.

If a reusable unit of a part is rejected due to very large number of times of reuse in the past, the unit may be excluded from the consideration for setting the acceptable maximum past service time of the part. Thus more practical reusable-part choosing conditions can be set.

The reusable-part choosing conditions set as described above are entered in the second column 534 of FIG. 5 table 530 and used as supplying conditions for reusable parts.

In accordance with this method, the choosing conditions of reusable parts can be derived from their actual results. Namely, the reusable-part choosing-condition database 23c, of which an example is shown in FIG. 5 table 530, can be modified by accumulating data in the reusable-part record-management database 23f, of which an example is shown in table 540, and making use of the database 23f. Thus the reusable-part choosing-condition database 23c grows. Every time reusable parts are procured, the efficiency of procurement of reusable parts increases.

Although the results of reusable parts are managed by part names in the above example, the results may be managed by kinds of parts (for example, HDD, memory, and PCB). In this case, the first column of the reusable-part record-management database 23f holds kinds of parts. By using the kinds-of-parts database 23h, of which an example is shown in FIG. 6 table 630, to relate kinds of parts to part names, data can be processed.

The data in the reusable-part record-management database 23f may be added up by part names or by kinds of parts.

$$Yield of reusable parts = \frac{Quanitity of non \text{-} defectives by user ' s standard}{Quantity procured} \times 100 ( \% ) \qquad [ Equation 14 ]$$

By using the above Equation 14, the yield of reusable parts (the ratio of the quantity of non-defectives by user's standard to the quantity procured) can be calculated.
Quantity of each part to be procured=Necessary quantity of said part×[1+(100−yield)/100] [Equation 15]

By using the yield of each part or each kind of parts and the above Equation 15, the necessary quantity of each part or each kind of parts to be procured can be calculated. By using Equation 5 additionally, the quantity of reusable parts to be procured which satisfies the target ratio of reusable parts can be calculated.

Thus the actual yields of reusable parts can be taken into account and necessary quantities of reusable parts can be procured.

In order to illustrate the process of obtaining a reusable part, an example of a user, e.g., manufacturer D, purchasing a used floppy disk, e.g., FDD-A part, is given. The user determines that the FDD-A requirements (choosing conditions) are 10,000 hours or less service time, 3 times or less reuse, quantity 2, and 10 days or less delivery time. Some of this information is included in FIG. 5 table 530 row 539 of user database 23c. The requirements sent to the supplier are shown in FIG. 7, procurement information 717 for part name 715, FDD-A 730. These requirements include: 10,000 hours or less service time 723, 3 times or less reuse 734, quantity 2 736, and 10 days or less delivery time 738.

The supplier upon receiving the user requirements, searches its database 23d, e.g. FIG. 9 table 910, for parts which meet or exceed the user's requirements (i.e., those rows with reusable part conditions 914 that meet or exceed the reusable part choosing conditions 534 of FIG. 5, table 530). Here, for example, rows 950, 952, and 954 meet or exceed the requirements. Row 956 has a FDD-A with a service time of 9000 hours, but a reuse of five (5) times which falls below, i.e., is worse than, the reuse requirement of 3 or less 734. The three available parts (rows 950, 952 and 954) and their individual histories are sent back to the user, as shown in FIG. 7 under Availability information 718. This includes: a first part with service time of 6000 hours 740, reuse of twice 742, delivery time of 9 days 744, and a price of 250 yen 746, a second part with service time of 7000 hours 750, reuse of once 752, delivery time of 4 days 754, and a price of 300 yen 756. And a third part with service time of 8000 hours 760, reuse of once 762, delivery time of 5 days 764, and a price of 280 yen 766.

The user in this case, selects the first two items by checking boxes 770 and 772, as he/she only needs two FDD-A's, and selects the order button 780. The two FDD-A's ordered are recorded in the supplier's database 23d (FIG. 9) rows 950 and 952, columns 930 to 942 (booked user is Manufacturer D) and in user's database FIG. 5 table 540 rows 550 and 552, which shows the FDD-A with 6000 and 7000 hours service time along with other history information. Also user database 23b is updated to include in rows 560 and 562, the two reusable parts and their scheduled dates of delivery. Upon receipt of delivery of the two reusable parts the user performs inspection and enters the results in table 540. If the parts are acceptable, i.e., pass inspection, the user manufactures the new products with the reusable parts.

Another embodiment of the present invention, which involves a broker, will now be described.

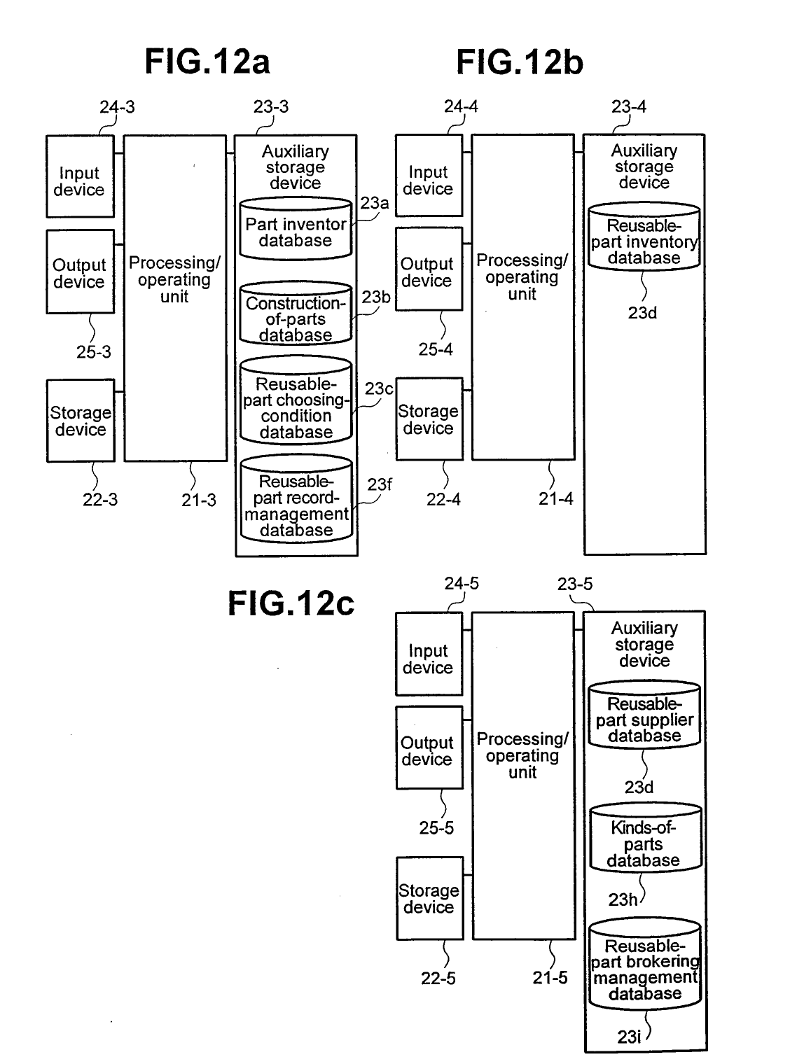

FIG. 11 shows the whole configuration of devices in accordance with this embodiment.

Referring to drawings, this embodiment will be described below.

The system of this embodiment comprises operational units 11-3 to 11-7, such as personal computers, display devices such as displays 12-3 to 12-7, and input devices such as keyboards 13-3 to 13-7, and mice 14-3 to 14-7. In addition, the following devices may be used: a network 16 such as the Internet to connect traders concerned, devices installed in the operational units 11-3 to 11-7 r otherwise provided for the connection to the network 16, and devices to read external storage media such as floppy disk drives, CD drives, and MO drives installed to the operational units 11-3 to 11-7. If printers 15-3 to 15-7 are used in addition to the displays 12-3 to 12-7, results can be seen in a printed form. In FIG. 11, two sets of such devices are for users “A” 1110 and “B” 1120 of reusable parts; two sets, for suppliers “C” 1130 and “D” 1140 of reusable parts; and one set, for a broker of reusable parts 1150. The five sets of devices are connected to one another by the network 16. Although these devices are connected to one another by wires in FIG. 1, they may otherwise be connected to one another, for example wireless or optical fibre. Besides, although two users, two suppliers, and one broker of reusable parts are connected to one another, each type of trader may be single or plural in number.

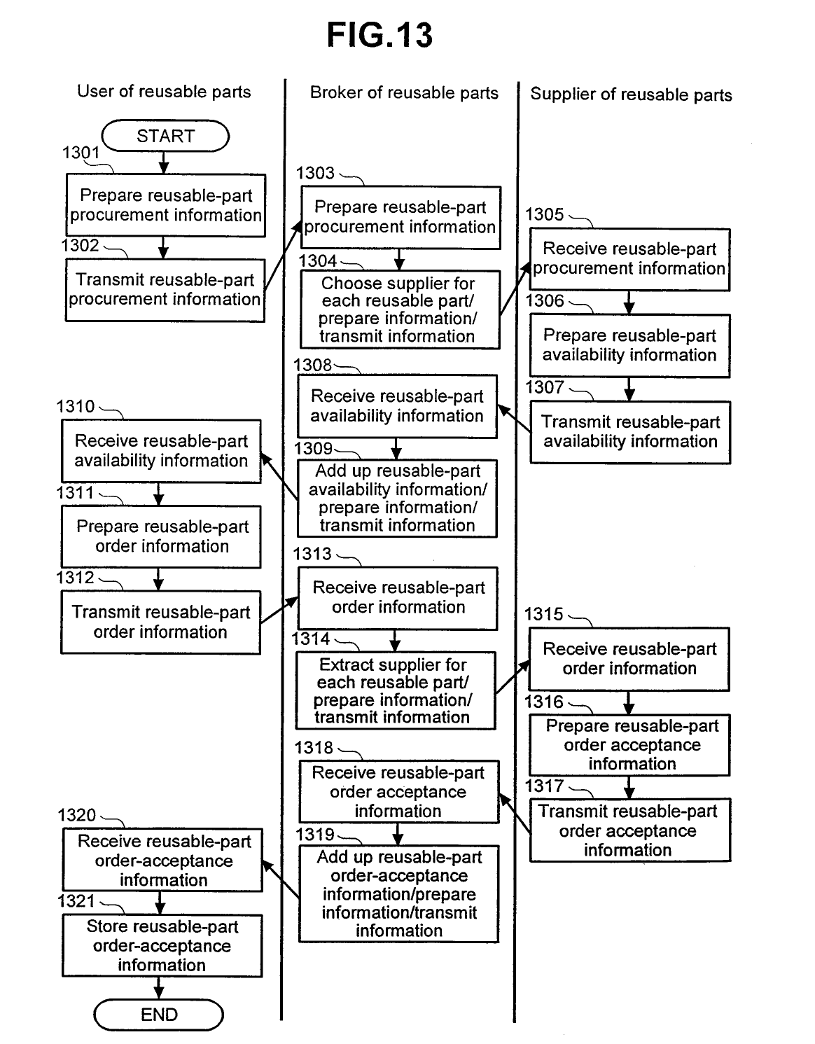

FIG. 12a shows an example of system configuration for each user of reusable parts in accordance with an embodiment of the present invention; FIG. 12b, for each supplier of reusable parts; and FIG. 12c, for the broker.

The system for each user of reusable parts (FIG. 12 a) comprises a processing/operating unit 21-3 such as a CPU for personal computers, a storage device 22-3 such as a semiconductor memory, an auxiliary storage device 23-3 such as a HDD, and an input device 24-3 and an output device 25-3 of which examples are shown in FIG. 11. The auxiliary storage device 23-3 comprises a part inventory database 23a to record parts in stock, etc., a construction-of-parts database 23b to memorize the construction of products, etc., a reusable-part choosing-condition database 23c, and a reusable-part record-management database 23f.

The system for each supplier of reusable parts (FIG. 12b) comprises a processing/operating unit 21-4 such as a CPU for personal computers, a storage device 22-4 such as a semiconductor memory, an auxiliary storage device 23-4 such as a HDD, and an input device 24-4 and an output device 25-4 of which examples are shown in FIG. 11. The auxiliary storage device 23-4 comprises a reusable-part inventory database 23d to record reusable parts in stock, etc.

The system for the broker of reusable parts (FIG. 12c) comprises a processing/operating unit 21-5 such as a CPU for personal computers, a storage device 22-5 such as a semiconductor memory, an auxiliary storage device 23-5 such as a HDD, and an input device 24-5 and an output device 25-5 of which examples are shown in FIG. 11. The auxiliary storage device 23-5 comprises a reusable-part supplier database 23g to record suppliers of reusable parts, a kinds-of-parts database 23h to record kinds of parts and the names or the model designations of parts, and a reusable-part brokering management database 23i.

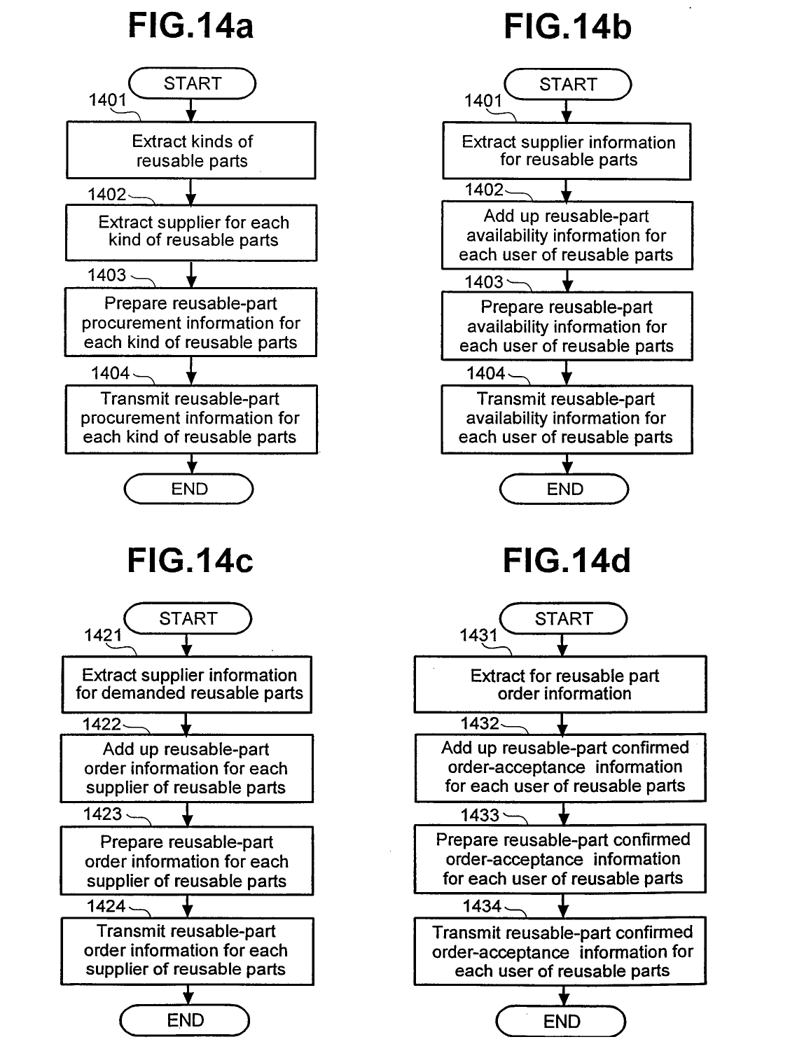

FIG. 13 shows the whole process of the system of an embodiment of the present invention.

Each user of reusable parts prepares reusable-part procurement information in Step 1301 and transmits the reusable-part procurement information to the broker of reusable parts in Step 1302. Steps 1301 and 1302 are similar to Steps 301 and 302.

In Step 1303, the broker of reusable parts receives the reusable-part procurement information which was transmitted by each user of reusable parts in Step 1302. The contents of the reusable-part procurement information transmitted and received in Steps 1302 and 1303 are similar to those transmitted and received in Steps 302 and 303. Besides, the transmitting and receiving method of the present embodiment is similar to that of the previous embodiment.

In Step 1304, the broker of reusable parts searches the kinds-of-parts database 23h, based on the reusable-part procurement information, for suppliers of the demanded reusable parts. Besides, the broker of reusable parts searches the reusable-part supplier database 23g, based on the reusable-part procurement information, for information on the suppliers. Based on the information extracted by the search, the broker prepares reusable-part procurement information for each supplier and transmits the reusable-part procurement information to said supplier. The processing method to be used in Step 1304 will be described later.

In Step 1305, each supplier receives the reusable-part procurement information which was transmitted by the broker of reusable parts in Step 1304. The contents of the reusable-part procurement information transmitted and received in Steps 1304 and 1305 are the same as those transmitted and received in Steps 302 and 303 to which identification information such as a serial number to identify the reusable-part procurement information is added.

In Step 1306, each supplier searches the information on reusable parts in stock based on the reusable-part procurement information received in Step 1305 and prepares reusable-part availability information. In Step 1307, each supplier transmits the reusable-part availability information to the broker of reusable parts who transmitted the reusable-part procurement information in Step 1304. Steps 1305 to 1307 are similar to Steps 303 to 305.

In Step 1308, the broker of reusable parts receives the reusable-part availability information transmitted by each supplier in Step 1307. When reusable-part procurement information is transmitted to a plurality of suppliers of reusable parts in Step 1304, the broker of reusable parts receives the reusable-part availability information from each supplier of reusable parts in Step 1308. The contents of the reusable-part availability information transmitted and received in Steps 1307 and 1308 are similar to those transmitted and received in Steps 305 and 306 of the previous embodiment to which the identification information to identify the reusable-part procurement information transmitted and received in Steps 1304 and 1305 is added.

In Step 1309, the broker of reusable parts adds up the reusable-part procurement information prepared for each supplier in Step 1304 for each user of reusable parts to the information received in Step 1303 for each user of reusable parts and prepares reusable-part availability information for each user of reusable parts. The reusable-part availability information for each user of reusable parts is recorded in the reusable-part brokering management database 23i and transmitted to said user of reusable parts who transmitted the reusable-part procurement information in Step 1302. The processing in Step 1309 will be described in detail later.

In Step 1310, each user of reusable parts receives the reusable-part availability information transmitted by the broker of reusable parts in Step 1309. The contents of the reusable-part availability information transmitted and received in Steps 1309 and 1310 are similar to those transmitted and received in Steps 305 and 306 of the previous embodiment to which identification information such as a serial number to identify the reusable-part availability information is added. The broker of reusable parts records, in the reusable-part brokering management database 23i, the serial number to identify the reusable-part availability information and information relating the serial number to the reusable-part availability information transmitted by the relevant supplier in Steps 1307 and 1308. If the broker of reusable parts transmits its reusable-part procurement information to two or more suppliers of reusable parts based on one piece of reusable-part procurement information from a user of reusable parts, two or more pieces of information are processed in Steps 1307 and 1308 whereas one piece of information is processed in Steps 1309 and 1310 as far as the user is concerned.

In Step 1311, each user of reusable parts determines which parts to procure based on the reusable-part availability information and prepares reusable-part order information. In Step 1312, each user of reusable parts transmits the reusable-part order information to the broker of reusable parts who transmitted the reusable-part availability information in Step 1309. Steps 1310 to 1312 are similar to Steps 306 to 308.

In Step 1313, the broker of reusable parts receives the reusable-part order information transmitted by each user of reusable parts in Step 1312. The contents of the reusable-part order information transmitted and received in Steps 1312 and 1313 are similar to those transmitted and received in Steps 308 and 309 of the previous embodiment to which the identification information to identify the reusable-part procurement information transmitted and received in Steps 1309 and 1310 is added.

In Step 1314, based on the reusable-part order information received in Step 1312 and the reusable-part availability information recorded in the reusable-part brokering management database 23i in Step 1309, the broker of reusable parts prepares reusable-part order information for each supplier of reusable parts and transmits the reusable-part order information to said supplier. The processing method in Step 1314 will be described in detail later.

In Step 1315, each supplier of reusable parts receives the reusable-part order information transmitted by the broker of reusable parts in Step 1314. The contents of the reusable-part order information transmitted and received in Steps 1314 and 1315 are similar to those transmitted and received in Steps 308 and 309 of the previous embodiment to which the identification information to identify the reusable-part procurement information transmitted and received in Steps 1312 and 1313 is added.

In Step 1316, each supplier of reusable parts accepts the order based on the reusable-part order information and prepares order-acceptance information. In Step 1317, each supplier of reusable parts transmits the reusable-part order-acceptance information to the broker of reusable parts who transmitted the reusable-part order information in Step 1314. Steps 1315 to 1317 are similar to Steps 309 to 311.

In step 1318, the broker of reusable parts receives the reusable-part order-acceptance information transmitted by each supplier of reusable parts in Step 1317. The contents of the reusable-part order-acceptance information transmitted and received in Steps 1317 and 1318 are the same as those transmitted and received in Steps 311 and 312 of the previous embodiment to which the identification information to identify the reusable-part procurement information transmitted and received in Steps 1314 and 1315 is added.

In Step 1319, the broker of reusable parts adds up the reusable-part order information prepared for each supplier in Step 1314 to the information received in Step 1313 for each user of reusable parts and prepares reusable-part order-acceptance information for each user of reusable parts. The reusable-part order-acceptance information for each user of reusable parts is recorded in the reusable-part brokering management database 23i and transmitted to said user of reusable parts who transmitted the reusable-part order information in Step 1312. The details of Step 1319 will be described later.

In Step 1320, each user of reusable parts receives the reusable-part order-acceptance information transmitted in Step 1319. The contents of the reusable-part order-acceptance information transmitted and received in Steps 1319 and 1320 are similar to those transmitted and received in Steps 311 and 312 of the previous embodiment to which the identification information to identify the reusable-part procurement information transmitted and received in Steps 1317 and 1318 is added.

In Step 1321, each user of reusable parts stores and manages the reusable-part order-acceptance information. Steps 1320 and 1321 are similar to Steps 312 and 313.

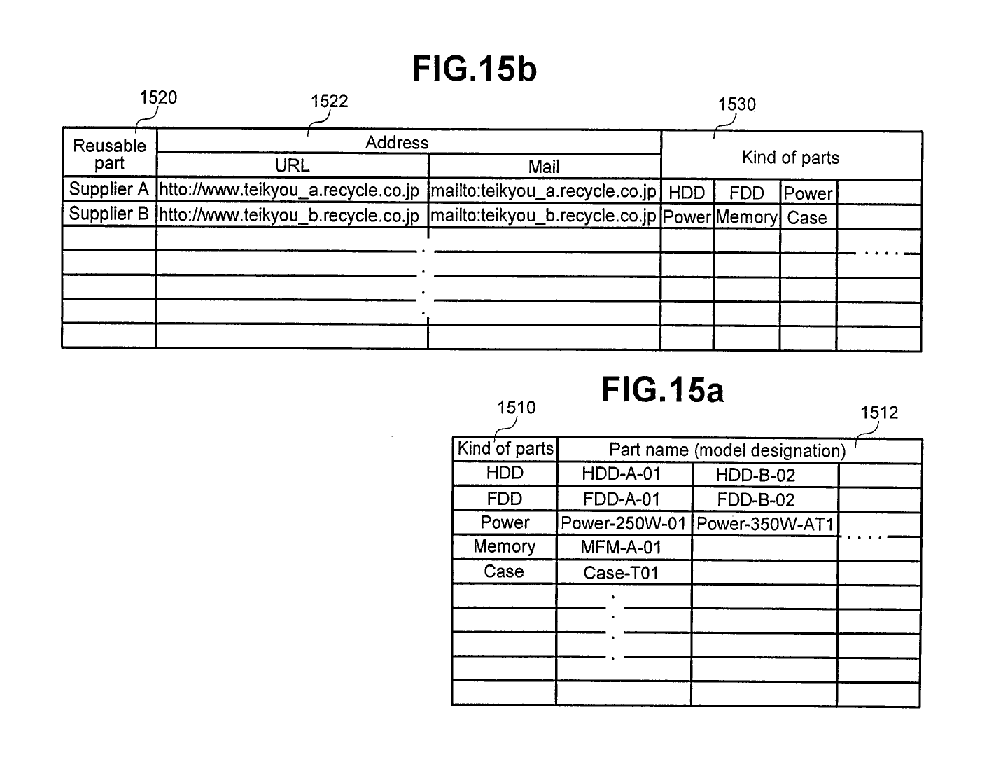

FIG. 14 shows the process on the side of the broker of reusable parts of an embodiment of the present invention.

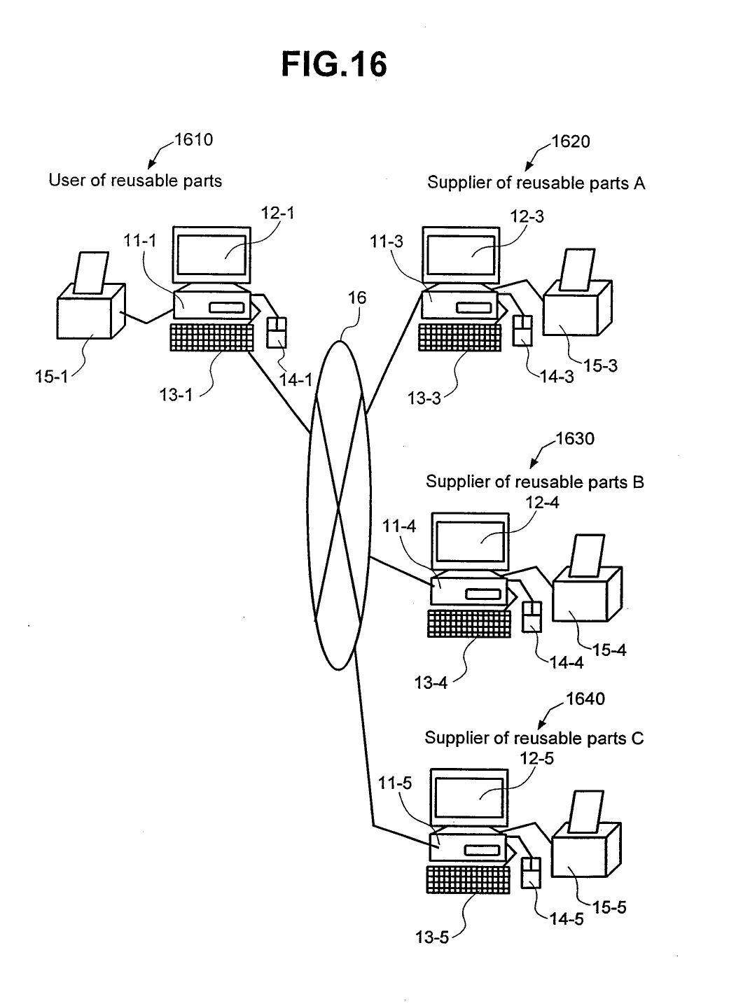

FIG. 14a shows the details of Step 1304. In Step 1401, based on the part names of the reusable-part procurement information received from each user in Step 1303, the broker searches the first and second columns of the kinds-of-parts database 23h, of which an example is shown in FIG. 15a, for the kinds of parts corresponding to the part names. The kinds-of-parts database 23h holds kinds of parts in the first column 1510 and part names in the second column 1512.

In Step 1402, by using the kinds of parts extracted in Step 1401, the broker searches the first 1520 and third columns 1530 of the reusable-part supplier database 23g (FIG. 15b) for suppliers of the kinds of parts. Further, by recording addresses of suppliers of reusable parts in the second column 1522, the way to contact the supplier in concern of usable parts can be extracted. The reusable-part supplier database 23g, as illustrated by FIG. 15b includes supplier names in the first column 1520, addresses of suppliers in the second column 1522, and kinds of parts to be handled by each supplier in the third column 1530.

If the part names in the second column 1512 of the kinds-of-parts database 23h are recorded in the third column 1530 of the reusable-part supplier database 23g, suppliers can be identified directly from the part names of the reusable-part procurement information received in Step 1303.

In Step 1403, based on the reusable-part procurement information of each user, the broker prepares reusable-part procurement information for each supplier extracted in Step 1402. Identification information identifying said user in addition to the reusable-part procurement information such as part names, choosing conditions, and dates of delivery are also prepared. Alternatively identification information such as a serial number may be allotted to each piece of the reusable-part procurement information to be prepared in Step 1403 and the serial numbers are related to the reusable-part procurement information received from said user in Step 1303. If users present prices at which they hope to purchase, it is desirable for the broker to deduct a certain percentage or amount from such prices before presenting them to suppliers. The difference between the former and latter prices is the income of the broker.

In Step 1404, the broker transmits the reusable-part procurement information prepared in Step 1403 to the suppliers extracted in Step 1402.

FIG. 14b shows the details of Step 1309. In Step 1411, the broker extracts the identification information allotted to each available part and identifying the user from each piece of reusable-part procurement information received in Step 1308 in order to identify the user who transmitted said piece of reusable-part procurement information.

In Step 1412, based on the identification information of the user of each part extracted in Step 1411, the broker adds up the reusable-part availability information received in Step 1308 for each user. If the broker transmitted reusable-part procurement information to two or more suppliers based on the reusable-part procurement information from one user, the broker adds up two or more pieces of reusable-part availability information for the user. If two or more suppliers transmit reusable-part availability information in response to one and the same reusable-part procurement information, the broker chooses the part which is closest to the reusable-part procurement information received in Step 1303. In such a case, they are prioritized based on such conditions prescribed in advance as lower (or higher) price, longer (or shorter) service time in the past, and smaller (or larger) number of times of reuse in the past. Thus, reusable parts can be offered efficiently. The above choice can be made by an ordinary sorting function and it can easily be accomplished by the existing technology.

In Step 1413, the broker prepares reusable-part availability information for each user. It is useful to attach identification information to each individual part to identify its supplier. To be more specific, the code of the supplier who transmitted the reusable-part availability information in Step 1307 is attached to each individual part in the reusable-part availability information in Step 1413. If suppliers present selling prices, it is desirable for the broker to add a certain percentage or amount to the selling prices before presenting them to users. The difference between the former and latter prices is the income of the broker.

In Step 1414, the broker transmits the reusable-part availability information prepared in Step 1413 to each user.

FIG. 14c shows the details of Step 1314. In Step 1421, the broker extracts the supplier identification information for each individual part included in the reusable-part order information received from users in Step 1313. The broker, using the extracted supplier identification information, adds up the reusable-part order information for each supplier in Step 1422 and prepares, based on the results of adding up, reusable-part order information for each supplier in Step 1423. The reusable-part order information includes identification information (for example, the code of each user) for identifying the user of each individual part in addition to the names and the required specifications of reusable parts. If users present prices at which they hope to purchase, it is desirable for the broker to deduct a certain percentage or amount from the prices before presenting them to suppliers. The difference between the former and latter prices is the income of the broker.

In Steps 1424, the broker transmits the reusable-part order information prepared in Step 1423 to each supplier.

FIG. 14d shows the details of Step 1319. In Step 1431, based on the reusable-part order-acceptance information which was received in Step 1318 and includes the identification information of the user of each individual part, the broker extracts the users of individual parts. The broker, using the extracted information on users, adds up the reusable-part order-acceptance information for each user in Step 1432 and, based on the results of adding up, prepares reusable-part order-acceptance information for each user in Step 1433. If suppliers present selling prices, it is desirable for the broker to add a certain percentage or amount to the selling prices before presenting them to users. The difference between the former and latter prices is the income of the broker.

In Step 1434, the broker transmits the reusable-part order-acceptance information prepared in Step 1433 to each user.

The extraction of specific information in Steps 1401, 1402, 1411, 1421, and 1431 and the adding up of specific information in Steps 1412, 1422, and 1432 are both being carried out in ordinary information systems.

In accordance with the above process, the user of reusable parts can have access to a plurality of suppliers through a broker in the same way as the user has direct access to a supplier. In addition, because the broker procures each user reusable parts from a plurality of suppliers, reusable parts can be procured efficiently. Moreover, it is not necessary for the supplier to deal with a plurality of users. By dealing with brokers, the supplier can obtain reusable-part procurement information from many users, which helps the supplier to simplify its business processing and expand its business. Offering an environment which raises the efficiencies of both users and suppliers, the broker can run its business stably, earning brokerage.

Still another embodiment, wherein one piece of reusable-part procurement information is presented to two or more suppliers and reusable parts are procured under better conditions, will be described below.

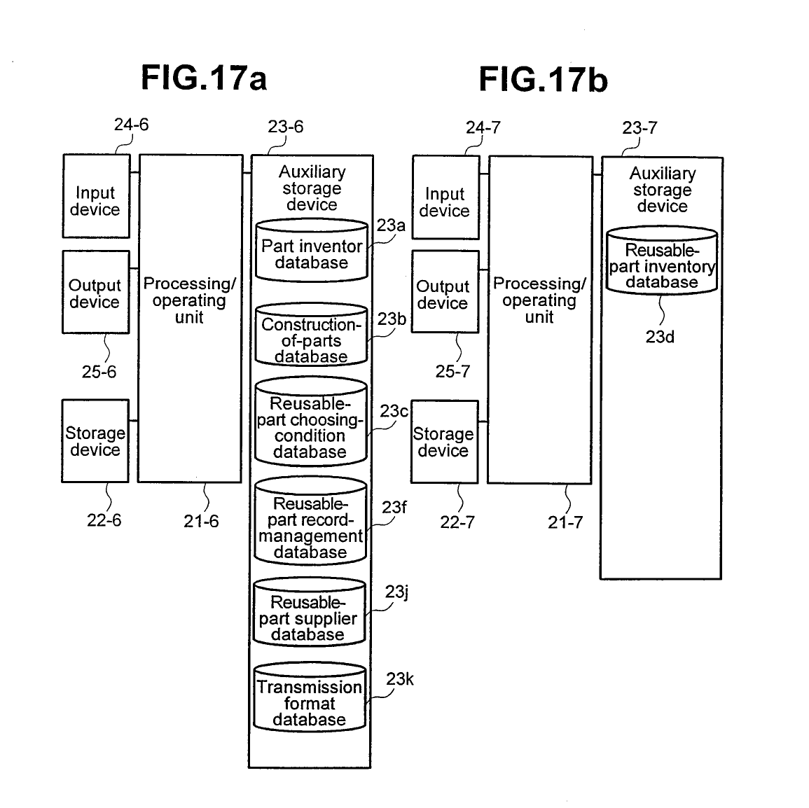

FIG. 16 shows the configuration of a system in accordance with the present embodiment.

Referring to drawings, the present embodiment will be described below.

The system of the present embodiment comprises operational units 11-1, 11-3 to 11-5, such as personal computers, display devices such as displays 12-1, 12-3 to 12-5, and input devices such as keyboards 13-1, 13-2 to 13-5 and mice 14-1 and 14-3 to 14-5. In addition, the following devices may be used: a network 16 such as the Internet to connect traders concerned, devices installed in the operational units 11 or otherwise provided for the connection to the network 16, and devices to read external storage media such as floppy disk drives, CD drives, and MO drives installed to the operational units 11-1, 11-3 to 11-5. If printers 15-1 and 15-3 to 15-5 are used in addition to the displays 12-1 and 12-3 to 12-5, results can be seen in a printed form. In FIG. 16, one set of such devices is for a user of reusable parts 1610; three sets, for three suppliers A 1620, B 1630, and C 1640 of the same, and the four sets of devices are connected to each other by the network 16. Although these devices are connected to one another by wires in FIG. 16, they may otherwise be connected to one another. Besides, although one user of reusable parts and three suppliers of the same are connected to one another, a plurality of users and a plurality of suppliers may be connected.

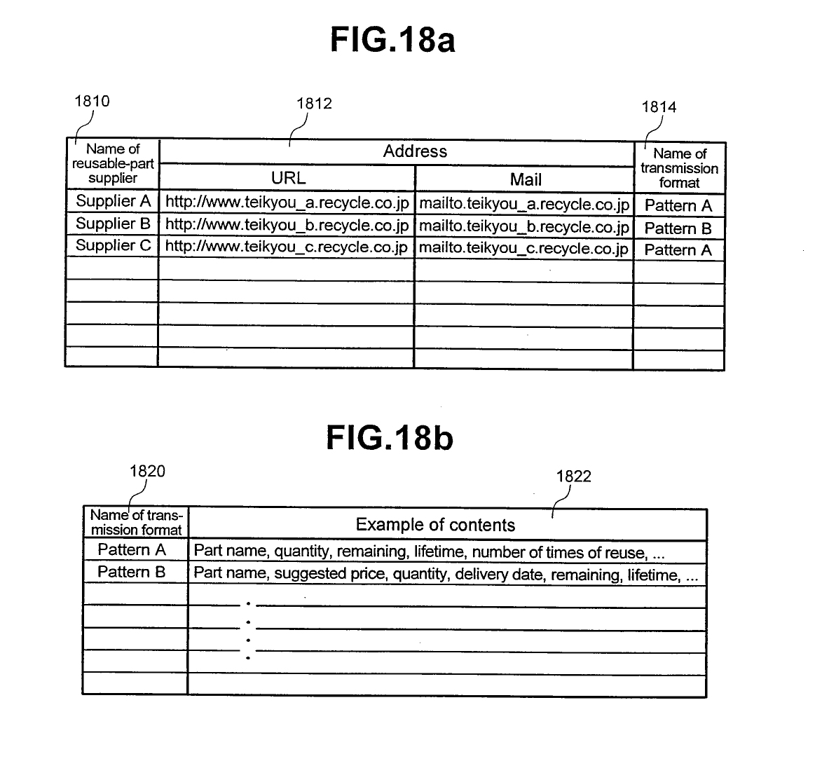

FIG. 17a shows an example of system configuration for the user of reusable parts 1610 in accordance with the present embodiment; FIG. 17b, shows an example for each of the suppliers A 1620, B 1630, and C 1640 of reusable parts.

The system for the user of reusable parts comprises a processing/operating unit 21-6 such as a CPU for personal computers, a storage device 22-6 such as a semiconductor memory, an auxiliary storage device 23-6 such as a HDD, and an input device 24-6 and an output device 25-6 of which examples are shown in FIG. 16. The auxiliary storage device 23-6 comprises a part inventory database 23a to record parts in stock, etc., a construction-of-parts database 23b to memorize the construction of products, etc., a reusable-part choosing-condition database 23c, a reusable-part record-management database 23f, a reusable-part supplier database 23j, and a transmission format database 23k. The configuration of the systems for the suppliers of reusable parts is similar to that of the previous embodiments.

The whole process of the present embodiment is similar to that shown in FIG. 3.

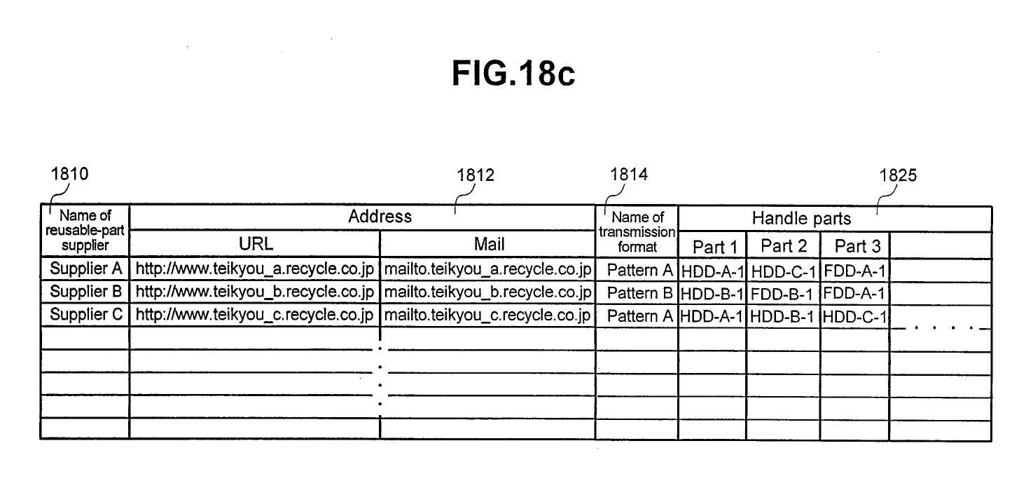

In Steps 301 and 302, however, the user of reusable parts searches the reusable-part supplier database 23j, of which an example is shown in FIG. 18a, for suppliers 1810 and extracts the addresses of suppliers from the second column 1812 and the names of their transmission formats from the third column 1814. Using the transmission format database 23k of which an example is shown in FIG. 18b, the user searches the first column 1820 for the names of their transmission formats and extracts their transmission formats from the second column 1822. The user prepares reusable-part procurement information in accordance with each supplier's transmission format and transmits the reusable-part procurement information to said supplier. It is assumed in the above description that the transmission formats of suppliers are different from one another. However, if the format for transactions of reusable parts is prescribed uniformly or relevant information was described in the XML (eXtensible Markup Language), the user need not use different formats for different suppliers and need not search the reusable-part supplier database 23j and the transmission format database 23k for the names of transmission formats and the transmission formats and extract them. Although the transmission formats are stored in the transmission format database 23k [in the second column 1822 of FIG. 18b], they may be stored in the reusable-part supplier database 23j [directly in the third column 1814 of FIG. 18a].

If the reusable-part supplier database 23j is expanded as shown in FIG. 18c to include the fourth column 1825 where the names of parts (or the initial letters of part names, or kinds of parts) of each supplier are held, the user can, in advance, choose suppliers of the reusable parts to be procured and transmits reusable-part procurement information to them. If methods of comparing letter strings such “forward matching” is used in the search of part names in the fourth column 1825 of FIG. 18c, not only the exact part names but also close ones can be extracted.

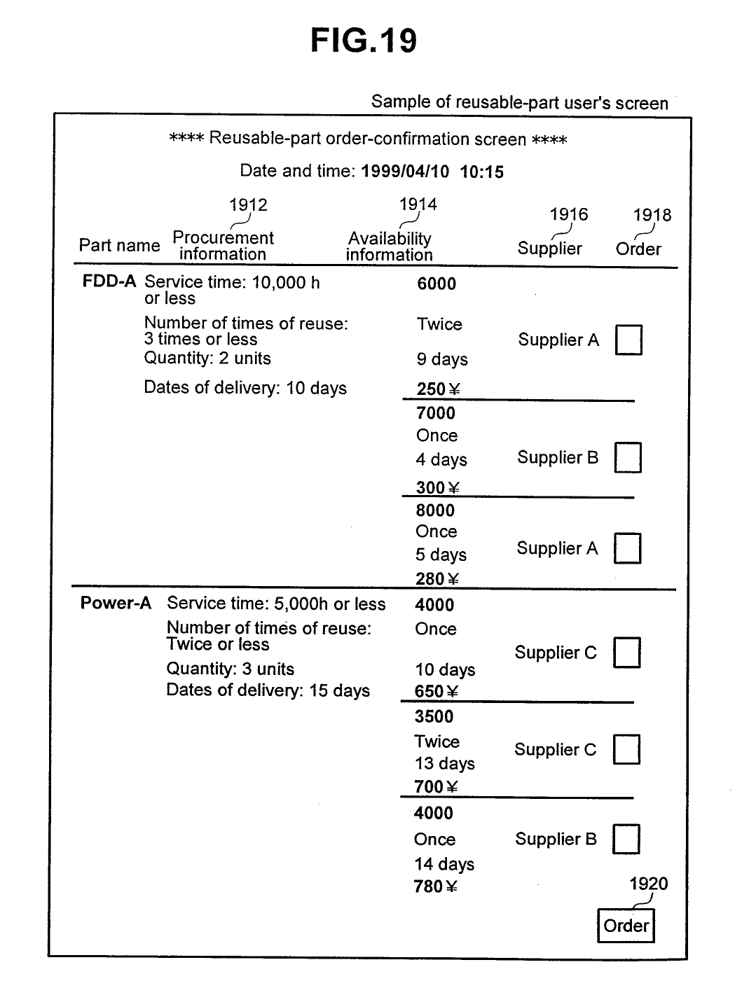

In Steps 306 to 308, the user receives reusable-part availability information from the suppliers whom the user transmitted reusable-part procurement information to. If available parts are prioritized based on such conditions set in advance as “lower price,” “shorter service time,” and “smaller number of times of use,” reusable parts can be procured more efficiently. It can be accomplished by an ordinary sorting function of the existing technology. If the reusable-part availability information from a supplier is in accord with the reusable-part procurement information, reusable-part order information may unconditionally prepared. Alternatively, such information as shown in FIG. 19 may be displayed to entrust the judgment to a manager. In FIG. 19, the manager compares the reusable-part procurement information 1912 and the reusable-part availability information 1914 transmitted from the suppliers 1916, puts a check mark in the order box of the best reusable part 1918, and push the “confirmation button” 1920. Thus, reusable-part order information is fixed. In Step 306, the fixed reusable-part order information is sorted out for each supplier and reusable-part order information for each supplier is prepared and transmitted to said supplier. The tasks in Step 306 are similar to those in Steps 1308 to 1314 of the second embodiment.

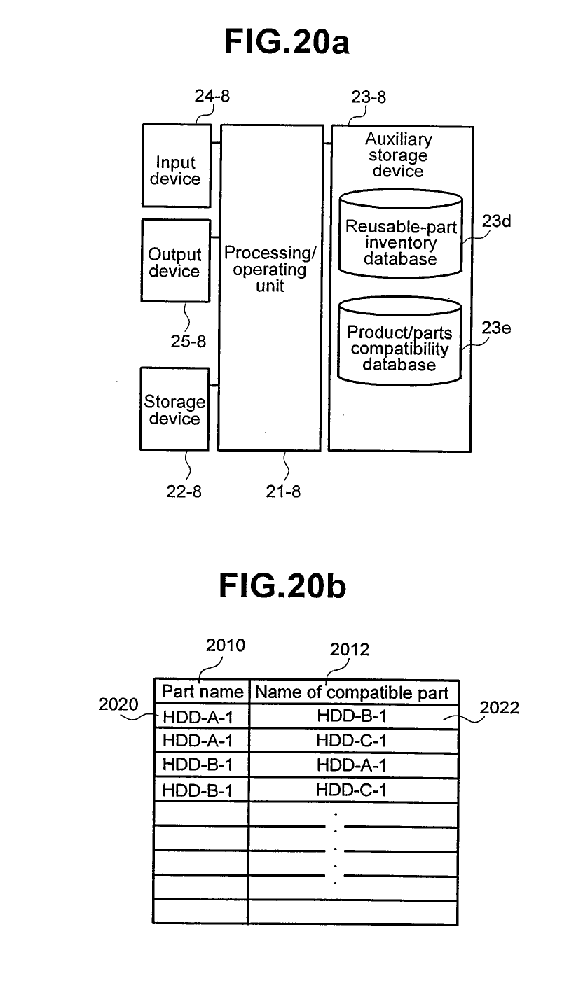

In another embodiment, a processing method when compatible parts exist will be described referring to FIG. 20.

FIG. 20a shows a system configuration for a supplier of reusable parts of an embodiment of the present invention. The system comprises a processing/operating unit 21-8 such as a CPU for personal computers, a storage device 22-8 such as a semiconductor memory, an auxiliary storage device 23-8 such as a HDD, and an input device 24-8 and an output device 25-8 of which examples are shown in FIG. 11. The auxiliary storage device 23-8 comprises a reusable-part inventory database 23d to record usable parts in stock, etc., and a product/parts compatibility database 23e storing information on a product/parts configuration and compatibility. As an example is shown in FIG. 20b, the product/parts compatibility database 23e holds part names in the first item 2010, and compatible part names in the second item 2012. Optionally, compatibility conditions may be a third item (not shown). As shown in the example of FIG. 20b, when there is a reusable-part supply request or a reusable-part order for “HDD-A-1”, in Step 802 and Step 812, a supplier of reusable parts searches according to the part name “HDD-A-1” before searching the reusable-part inventory database 23d. Then, when there are no applicable parts, the supplier of reusable parts repeats such procedures until compatible parts for “HDD-A-1” run out, for example as a search using “HDD-A-1” 2020 from the first item 2010 of the product/parts compatibility database 23e of which example is shown in FIG. 20b, extracting, for example, “HDD-B-1” 2022 as a compatible part in the second item 2012, and searching the reusable-part inventory database 23d according to the above compatible part name.

The product/parts compatibility database 23e is a database wherein compatible parts for part names in the first item are recorded in the second item, and information indicating parts in the second item can be used instead of parts in the first item is accumulated. However, it should be noted that the reverse, which means parts in the first item are compatible with respect to the parts of a part name recorded in the second item, does not necessarily hold true. It shows, for example, that, as called “upward compatibility”, a 6.4-GB HDD can be registered as an “upward-compatible part” with superior performance for a 4.3-GB HDD in the same series. However, when used reversely, the available capacity gets smaller, which cannot necessarily be called compatible. When there is compatibility with each other, it can be achieved by recording both parts in the both left and right sections afterwards.

According to this embodiment, the supplier of reusable parts can supply parts which are compatible with the parts concerned, even when the parts of the applicable part names for reusable-part procurement information or reusable-part order information are out of stock. Therefore, the number of parts supplied can be increased. Also, the user of reusable parts can procure compatible and equivalent parts even when their names are different. Therefore, it becomes possible to procure and use reusable parts efficiently.

In the above embodiment, the supplier of reusable parts is responsible for the part-compatibility management. However, the same effects can be achieved when a user of reusable parts or a broker of reusable parts manages the product/parts compatibility database 23e, which replaces the part names with compatible parts and transmits reusable-part procurement information or reusable-part order information to the supplier of reusable parts. Particularly, in the flow from Step 1304 to Step 1308, when reusable-part availability information transmitted from the supplier of reusable parts fails to match the reusable-part procurement information transmitted from the user of reusable parts in Step 1303, the broker of reusable parts repeats the Step 1304 by using compatible parts. In such a way, the extraction of information from reusable-part inventory in a wider range becomes possible, which means an improved service to the supplier of reusable parts.

Another embodiment of processing when compatible parts are available will be described.

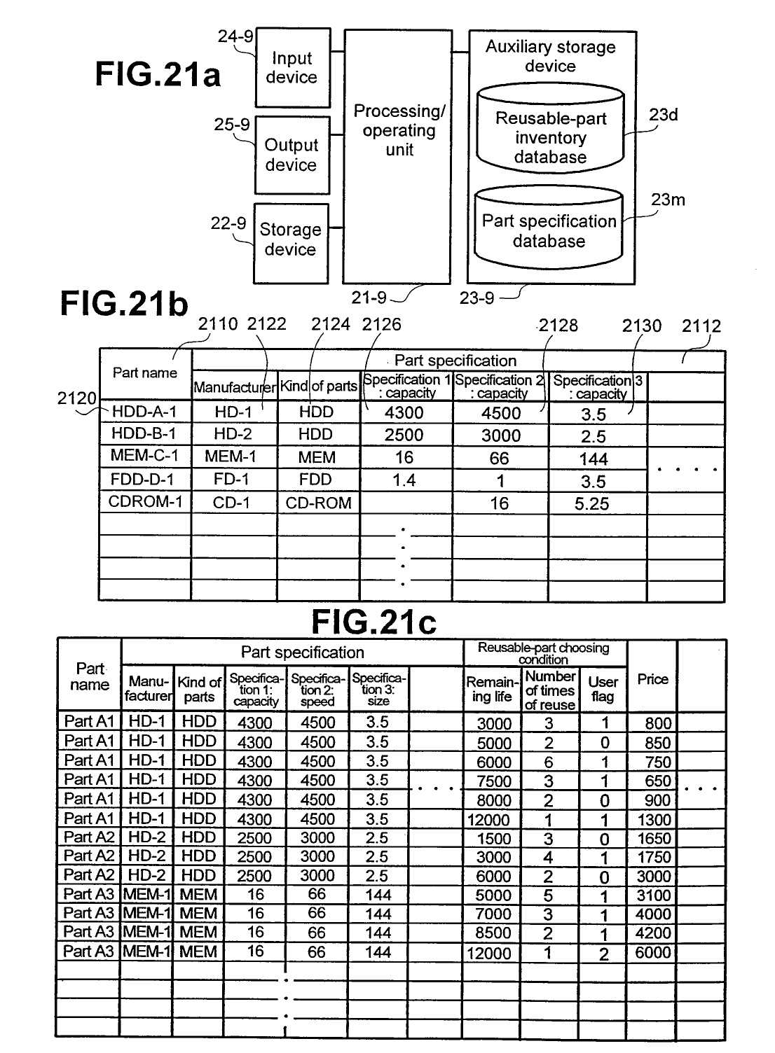

FIG. 21a shows a system configuration for a supplier of reusable parts of an embodiment of the present invention. The system comprises a processing/operating unit 21-9 such as a CPU for personal computers, a storage device 22-9 such as a semiconductor memory, an auxiliary storage device 23-9 such as a HDD, and an input device 24-9 and an output device 25-9 of which examples are shown in FIG. 11. The auxiliary storage device 23-9 comprises a reusable-part inventory database 23d to record reusable parts in stock, etc., and a part specification database 23m to store the construction of a product/parts and compatibility information, etc. As shown in FIG. 21b, the part specification database 23m holds part names in the first item 2110, and part specifications such as names of manufacturers, kinds of parts and various specifications (capacity, speed, size, etc.) in the second item 2112. In the example shown in FIG. 21b, the database includes such information as “HDD-A-1” 2120 is a HDD 2124 manufactured by HD-1 Company 2122, and has a capacity of 4,300 2126 (4.3 GB in the case of HDD), a speed of 4,500 2128 (4,500 rpm in the case of HDD) and a size of 3.5 2130 (3.5 inches in the case of HDD).

When searching the reusable-part inventory database 23d in Step 802 and Step 812, first, the supplier of reusable parts searches according to a part name. However, when there are no applicable parts, the supplier of reusable parts searches the part name concerned from the first item 2110 of the part specification database 23m, of which example is shown in FIG. 21b, and extracts its part specification in the second item 2112. Then, the supplier of reusable parts searches parts which meet or exceed all the extracted part specifications in the second item 2112 (all the items don't have to necessarily match, and it is enough to meet the conditions such as larger capacity and faster speed, etc. in the case of HDD) from the part specification database 23m, and extracts their part names. Then, the supplier of reusable parts searches the reusable-part inventory database 23d again according to the extracted part names.

According to this embodiment, it becomes possible for the supplier of reusable parts to supply parts which have equivalent specifications or better with those of the parts concerned even when there are no parts having the part names concerned with respect to reusable-part procurement information or reusable-part order information, and thereby to increase the number of parts to be supplied. Also, it becomes possible for the user of reusable parts to procure equivalent parts even when the part names are different and further to procure and utilize reusable parts efficiently.

In the above embodiment, the supplier of reusable parts is responsible for the management of part specifications. However, the same effects can be achieved when a user of reusable parts or a broker of reusable parts manages the part specification database 23m, which replaces the part names with compatible parts and transmits reusable-part procurement information or reusable-part order information to the supplier of reusable parts.

The user of reusable parts manages the part specification database 23m and carries out operations in Step 405 and Step 411 according to part specifications, and the supplier of reusable parts expands the reusable-part inventory database 23d as shown in FIG. 21c and manages the inventory according to part names and part specifications so that it may become possible to examine inventory and to receive or place orders not only by part names but also by part specifications.

Next, as yet another embodiment of the present invention, a method to conduct above procurement of the reusable parts through a network in real time.

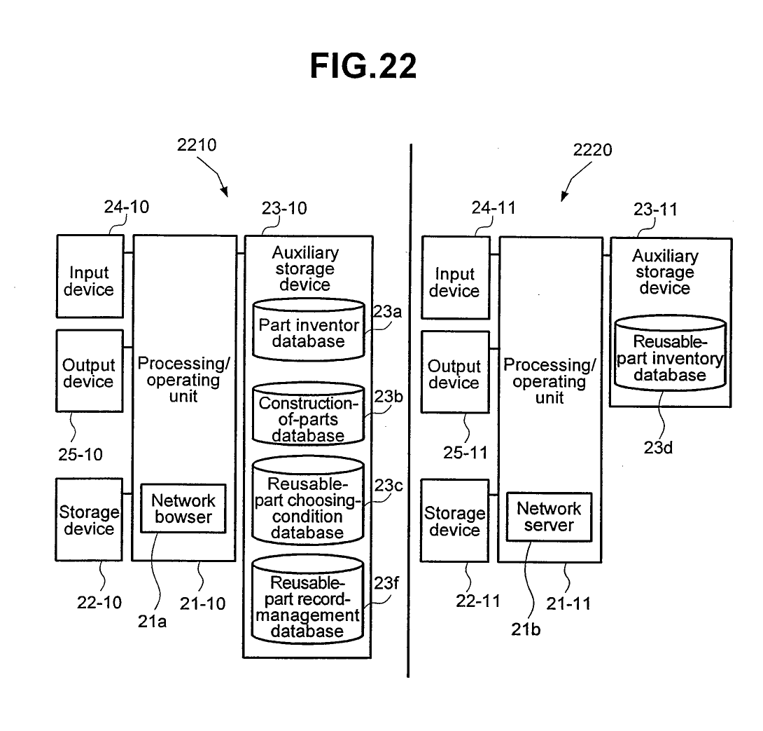

A whole configuration of devices of this embodiment will be shown in FIG. 22.

An embodiment of the present invention will be described referring to the drawings.

The whole configuration of devices in the present embodiment is the same as those shown in FIG. 1 (the ratio of reusable-part users and reusable-part suppliers is 1:1), FIG. 11 (the ratio of reusable-part users, reusable-part suppliers and reusable part brokers is 1: many:1) and FIG. 16 (the ratio of reusable-part users and reusable-part suppliers is 1:many). The example of FIG. 1 in which the ratio of reusable-part users and reusable-part suppliers is 1:1 will be described below. However, it is possible to expand this configuration in the same ways of the second and third embodiments.

FIG. 22 show respective system configurations for the user of reusable parts 2210 and the supplier of reusable parts 2220 in the present embodiment. The system configuration for the user of reusable parts 2210 comprises a processing/operating unit 21-10 such as a CPU for personal computers, a storage device 22-10 such as a semiconductor memory, an auxiliary storage device 23-10 such as a HDD, and an input device 24-10 and an output device 25-10 of which examples are shown in FIG. 16. The processing/operating unit 21-10 comprises a network browser 21a read from the auxiliary storage device 23-10. The auxiliary storage device 23-10 comprises a part inventory database 23a to record parts in stock, etc., a construction-of-parts database 23b to memorize the construction of products, etc., a reusable-part choosing-condition database 23c and a reusable-part record-management database 23f. The system configuration for the supplier of reusable parts 2220 comprises a processing/operating unit 21-11 such as a CPU for personal computers, a storage device 22-11 such as a semiconductor memory, an auxiliary storage device 23-11 such as a HDD, and an input device 24-11 and an output device 25-11 of which examples are shown in FIG. 1. Further, the processing/operating unit 21-11 comprises a network server 21b, and the auxiliary storage device 23-11 comprises a reusable-part inventory database 23d to record reusable parts in stock, etc.

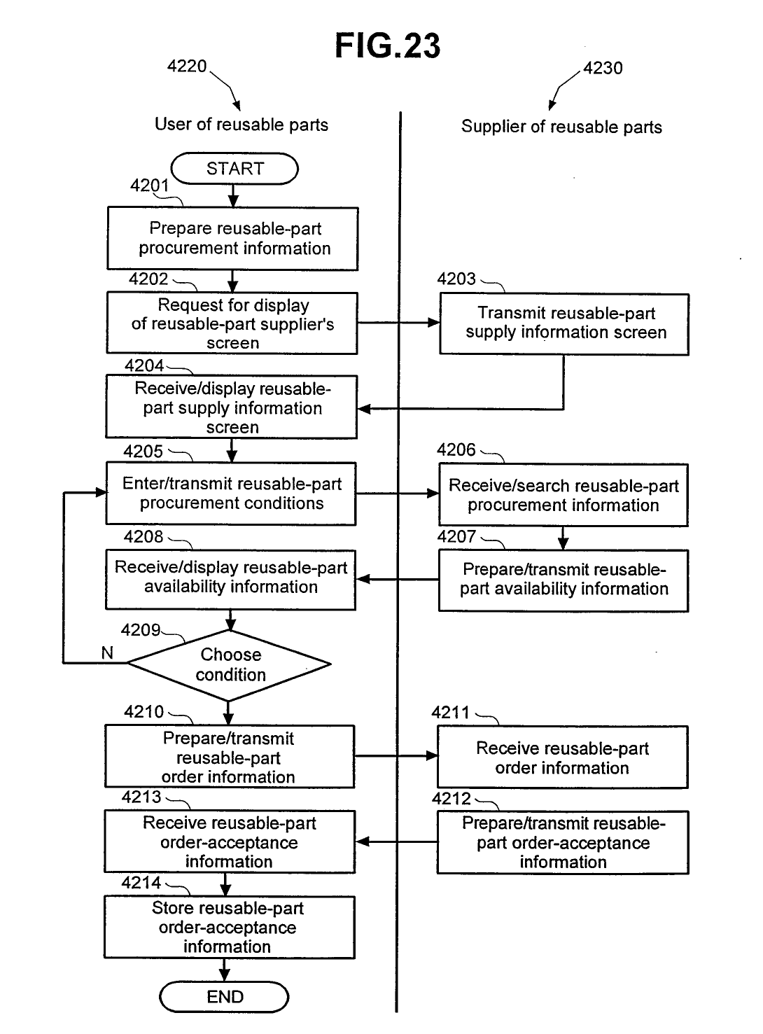

FIG. 23 shows the entire work flow of the present embodiment.

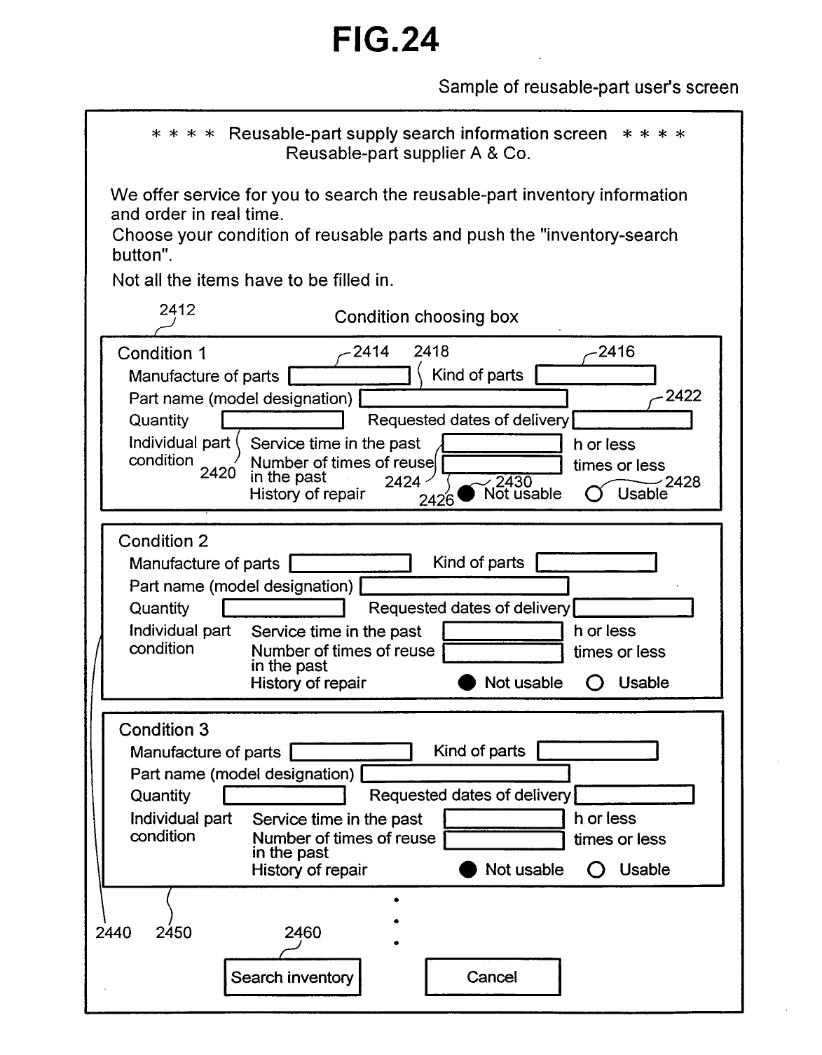

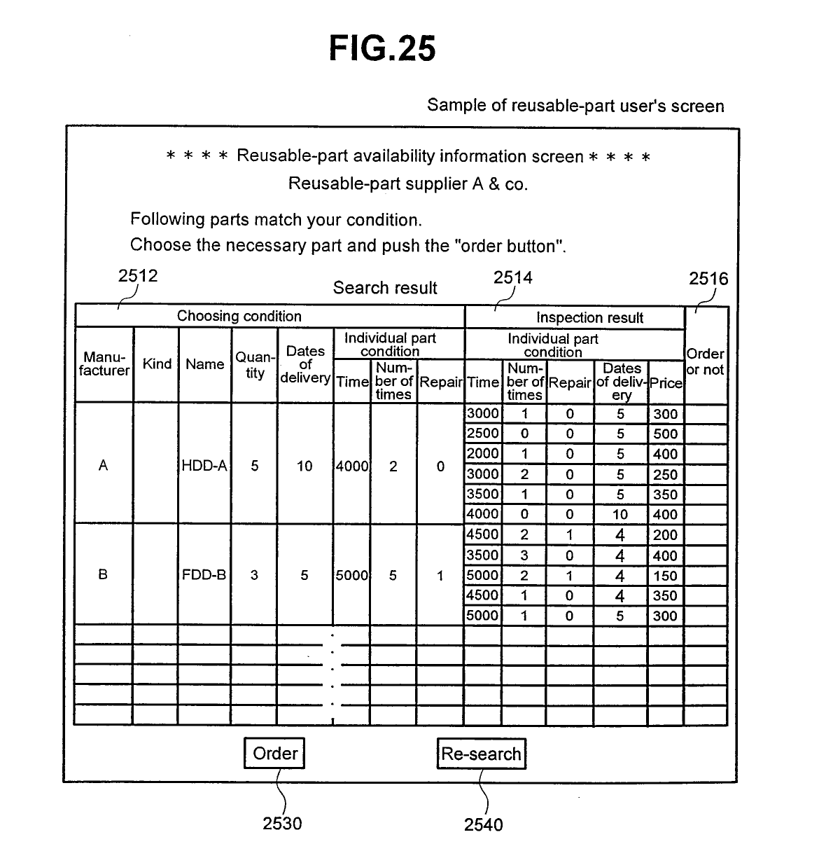

The user of reusable parts prepares reusable-part procurement information in Step 4201. This is the same as the process in Step 301. In Step 4202, the user of reusable parts gains access to the system for the supplier of reusable parts through a network, and demands a reusable-part availability information screen. Upon being connected with the user of reusable parts in Step 4202, the supplier of reusable parts transmits the reusable-part availability information screen, of which example is shown in FIG. 24 (Step 4203). In Step 4204, the user of reusable parts receives and displays the screen, and, in Step 4205, enters and transmits the conditions on the screen concerned which match the availability information. Upon receiving the reusable-part procurement conditions transmitted in Step 4205, the supplier of reusable parts searches the reusable-part inventory database 23d according to the conditions concerned (Step 4206). Being based on the result of the search, in Step 4207, the supplier of reusable parts prepares reusable-part availability information and transmits it to the user of reusable parts (the same as the processes in the Steps 1306 and 1307). The user of reusable parts receives the information concerned and displays it on the screen, of which example is shown in FIG. 25 (Step 4208). When there are no problems about the search according to the conditions concerned and the choosing of reusable parts (including the choice of parts described referring to FIG. 7, if required), the user of reusable parts prepares reusable-part order information according to the information concerned and transmits it to the supplier of reusable parts (Step 4210, of which processes are the same as in Step 307 and Step 308). Then, the supplier of reusable parts receives the information concerned (Step 4211, of which process is the same as in Step 309), prepares reusable-part order-acceptance information and transmits it to the user of reusable parts (Step 4212, of which process is the same as in Steps 310 and 311). The user of reusable parts receives the information concerned (Step 4213, of which process is the same as in Step 312), and stores/manages the reusable-part order information (Step 4214, of which process is the same as in Step 313).

When determining in the Step 4209 that the choice of the reusable parts is not sufficient and further adding conditions or narrowing or relaxing the conditions, the user of reusable parts returns to the Step 4205 and repeats the same operation.

It is possible to realize the system for the supplier of reusable parts by using a system combining a Web server, which is widely used on the internet, and a database. Also, the system for the user of reusable parts can be realized by using a Web browser.

Further, when proceeding to Step 4202, it becomes possible to provide the present service exclusively to the registered members by displaying the screen prompting an ID or a password managed in advance by the supplier of reusable parts for the entry of the ID or the password. Also, according to this method, if information such as names of reusable-part users and mailing addresses of products or contact addresses of clients are managed as ID information, it becomes possible to receive and order parts only by authenticating using IDs and passwords. This authentication can be achieved in the same way as the one commonly used on the internet.

The reusable-part availability information screen, of which example is shown in FIG. 24, has one or more boxes, for example, 2412, 2440, and 2450, where choosing information of history of the reusable parts, for example, service time 2424, reuse number 2426 or usable 2428 (not usable 2430), is entered, as well as information for each of the parts on regular part-procurement such as a part name 2418 (model designation), quantity 2420 and delivery dates 2422. With such information, it becomes possible to send the choosing condition of the applicable reusable parts to the supplier of reusable parts. Concerning each entry, besides the method wherein the user of reusable parts enters the condition, it is also effective to have a configuration such that the supplier of reusable parts transmits in advance a menu of choices for matching each item and an entry can be done when the user of reusable parts makes a choice. Further, these items of choosing conditions are shown only as examples, and condition settings such as kinds of parts 2416 and specification (HDD and 4 GB), for example, or a setting such as a manufacturer, kinds of parts and specification (A company, HDD, 4 GB) is also possible. Lastly, when the user of reusable parts pushes the “inventory search button” 2460, the entered information is transmitted to the supplier of reusable parts. Further, a plurality of conditions is set at the same time in the example shown in FIG. 24. However, it can be a format in which each condition is set one by one. In addition in the above embodiment, not all entries in a box must be set, for example, the manufacturer of parts 2414 may be left blank. Thus any manufacturer who meets the other conditions in box 2412, will be returned from the search.

On the reusable-part availability information screen, of which example is shown in FIG. 25, reusable-part procurement information transmitted in Step 4205 is shown on the choosing condition column 2512, and the result of the search according to the condition concerned in Step 4506 is shown on the inspection result column 2514. Further, a column 2516 for ordering the part concerned or not is provided. A person in charge can order a reusable parts by choosing a necessary part from the displayed parts and pushing the “order button” 2530. Also, further narrowing, etc. of the conditions can be achieved by simply pushing the “re-search button” 2540.

With respect to each condition, when more than the requested number of reusable parts are found, it is also practical to automatically choose from preset menus (this information can be stored together with previously described user management information using ID) such as “cheaper parts”, “parts of shorter service time” and “parts of fewer number of times of use”, in addition to the method of displaying all the (more than requested number of) applicable parts as shown in the example.

To automatically transmit the reusable-part procurement information determined in the above Step 4201 to the supplier of reusable parts, at the stage of calling up a screen in Step 4202, the information determined in the Step 4201 is transmitted at the same time as a parameter. The supplier of reusable parts, using that information, may put into practice the function of Step 4206 and then the function of Step 4207 as well as the rest of the Steps. This method is also commonly used when letting a system run on a Web server. According to this method, it becomes possible for both the reusable-part user and the reusable-part supplier to efficiently procure or provide parts with information specific to reusable parts, such as reusable-part choosing conditions, etc., by using a widely available system.

According to one embodiment of the present invention, when manufacturers, etc. procure reusable parts, considering the characteristics of reusable parts that their histories differ from part to part, it becomes possible to efficiently procure proper reusable parts from the supplier of reusable parts.

Further, it becomes possible for manufacturers to produce products using efficiently and properly procured reusable parts and to smoothly utilize the reusable parts in the products. Also, it similarly becomes possible for servicepersons or repairpersons to efficiently and properly procure reusable parts, and to proceed with maintenance or repairs using such parts.

Further, it becomes possible for the supplier of reusable parts to efficiently supply parts which meet the needs of the user of reusable parts from their inventory of reusable parts and to accurately understand the needs of the user of reusable parts and reflect it in procuring and stock planning of the reusable parts.

Also, it becomes possible for the broker of reusable parts to run a stable business based on income such as brokerage through the efficient mediation of reusable parts by providing proper reusable parts to the user of reusable parts while efficiently utilizing reusable-part inventory information of the contracted supplier of reusable parts.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. Therefore, it is to be understood that within the scope of the appended claims, the invention may be practiced otherwise than as specifically described.

What is claimed is:

1. An order system for placing an order for reusable parts, the order system comprising:
a construction-of-parts database that stores information related to at least parts and their component parts that compose product, and information on quantity of each component part required by the corresponding product or part;
a part inventory database that stores information related to name, the quantities of parts in stock, and scheduled date of delivery of the at least parts;
a reusable-part choosing-condition database that stores information on the at least parts name, service time in the past, number of times of reuse in the past, and number of times of repair;
a reusable-part record-management database that stores information on the at least parts name, and inspection result of each part;
a processing/operating unit that accepts, over the communication network, an input of the number of production of products to be manufactured, and calculates the number of each part that is necessary based on said construction-of-parts database;
wherein the processing/operating unit extracts quantities of the corresponding each part in stock based on said part inventory database, and calculates the number of each part that needs procurement;
wherein the processing/operating unit calculates the number of each reusable part that needs procurement from said number of each part that needs procurement and a target ratio predetermined for each reusable part;
wherein the processing/operating unit totals past inspection results information of said each reusable part that needs procurement based on said reusable-part record-management database, and decides the number of procurement of each reusable part;
wherein the processing/operating unit transmits a procurement order to at least one supplier of said reusable parts, the procurement order including information on a reusable-part choosing condition such as at least one of service time in the past, number of times of reuse in the past, number of times of repair, in addition to part name and the number of procurement of each reusable part;
wherein the processing/operating unit receives, over the communication network, reusable-part availability information from at least one supplier of reusable parts, the reusable-part availability information is stocked in the supplier's database and meets the requirement of the part name and the reusable-part choosing condition in the procurement order;
wherein the processing/operating unit confirms that the received reusable-part availability information meets the requirement of at least the dates of delivery, prices, and the reusable-part choosing condition, and orders the reusable parts that meet all requirements of pre-recording to the supplier of reusable parts.

2. The order system for placing an order for reusable parts according to claim 1,
wherein the reusable-part record-management database stores information on procurement of usable parts in the past, in each reusable part, in a data record form that includes part name, reusable-part choosing condition, and inspection result as data items;
wherein the processing/operating unit retrieves the data items of the inspection result of the data record with specific part name, and totals the retrieved data of the inspection result, and calculates the yield of reusable part with the specific part name based on the totaled data, and decides the number of procurement of the reusable part according to the calculated yield.

3. The order system for placing an order for reusable parts according to claim 1,
wherein a reusable-part target-ratio database stores the target ratio of reusable parts in each reusable part name or kind of parts;
wherein the processing/operating unit calculates the number of reusable parts to be procured every time with the equation:
Number of reusable parts to be procured=(number of reusable parts procured in the past+number of new parts procured in the past+number of all parts to be procured)×(target ratio of reusable parts to all parts to be procured number of reusable parts procured in the past).

4. An order-acceptance system for accepting an order placed for reusable parts, the order-acceptance system comprising:
a reusable-part inventory database that stores information relating to one or more reusable parts, the information comprising at least part name, reusable-part choosing condition such as at least one of service time in the past, number of times of reuse in the past, and number of times of repair, and prices of individual parts;
a product/parts compatibility database that stores information relating to part name and compatible part name as a pair;
a processing/operating unit that accepts, over the communication network, from a procurement user of reusable parts, an input of reusable-part procurement information including part name, the quantities of reusable parts to be procured, and reusable-part choosing condition such as at least one of a number that indicates service time in the past, a number of times of reuse in the past, and a number of times of repair;
wherein the processing/operating unit extracts registered reusable-parts from the reusable-part inventory database as reusable parts that can be offered, in the conditions that the part name of the registered reusable-part is the same as the part name in the reusable-part procurement information, and the reusable-part choosing condition of the registered reusable-part is a number less than those corresponding in the reusable-part procurement information;
wherein the processing/operating unit retrieves a compatible part name in the product/parts compatibility database by part name in the reusable-part procurement information, and if a compatible part name is extracted, retrieves and extracts registered reusable-parts from the reusable-part inventory database as reusable parts that can be offered, by using the condition that the part name of the registered reusable-part is the same as the compatible part name, and the reusable-part choosing condition of the registered reusable-part is less than those in the reusable-part procurement information;
wherein the processing/operating unit comprises a reusable-part availability information including at least a reusable part name, reusable-part choosing condition, dates of delivery, and prices, based on the extracted reusable parts that can be offered, and transmits the reusable-part availability information to the procurement user of reusable parts who transmitted the reusable-part procurement information;
wherein the processing/operating unit receives a reusable-part order information from the procurement user of reusable parts and registers an order-acceptance information to the reusable-part inventory database.

5. The order-acceptance system of accepting an order for reusable parts according to claim 4,
wherein the reusable-part inventory database stores further booking information of each reusable part that can be offered, in each data-record;
wherein the processing/operating unit accepts a reusable-part procurement information from the procurement user of reusable parts, and registers booking information of each reusable part that can be offered, to the reusable-part inventory database, and the reusable parts of which the booking is effective are excluded from the inventory, and the user of reusable parts booked in the reusable-part inventory database is given priority for ordering the reusable parts booked in the database.
